(19) United States
(12) Patent Application Publication
(10) Pub. No.: US 2025/0003801 A1
(43) Pub. Date: Jan. 2, 2025

(54) PHOTODETECTOR FOR MEASURING OPTICAL RADIATION

(71) Applicant: TRINAMIX GMBH, Ludwigshafen Am Rhein (DE)

(72) Inventors: Bernd SCHERWATH, Ludwigshafen am Rhein (DE); Celal Mohan OEGUEN, Ludwigshafen am Rhein (DE); Thomas HUPFAUER, Ludwigshafen am Rhein (DE); Christoph PROKOP, Ludwigshafen am Rhein (DE)

(21) Appl. No.: 18/709,539

(22) PCT Filed: Dec. 14, 2022
(86) PCT No.: PCT/EP22/85822

§ 371 Date: May 13, 2024

(30) Foreign Application Priority Data
Dec. 15, 2021 (EP) 21214763.1

(51) Int. Cl. G01J 3/42; G01J 3/02; G01J 3/28

(52) U.S. Cl. CPC G01J 3/42; G01J 3/0297; G01J 3/2803

(57) ABSTRACT

Disclosed herein is a photodetector for measuring optical radiation. The photodetector includes:
at least one active pixel including an active photosensitive region, where the active pixel is configured for generating at least one active signal by using the active photosensitive region, where the active signal is dependent on an illumination of the active pixel by the optical radiation; and
at least one dark pixel including:
a dark photosensitive region, where the dark pixel is configured for generating at least one dark signal by using the dark photosensitive region, where the dark signal is independent on an illumination of the dark pixel by the optical radiation; and
a temperature equalizing cover configured for covering the dark photosensitive region at least against the optical radiation.

### TECHNICAL FIELD

The invention relates to a photodetector for measuring optical radiation, a spectral measurement device for spectrally analyzing optical radiation provided by at least one measurement object, a method for spectrally analyzing optical radiation provided by at least one measurement object and various uses of the photodetector. Such devices and methods can, in general, be employed for various applications. As an example, such devices and methods can be used for investigation or monitoring purposes, in particular for infrared detection, heat detection, flame detection, fire detection, smoke detection, pollution monitoring, monitoring of an industrial process, a chemical process, a food processing process, a sorting process such as plastic sorting or textile sorting or the like. However, further kinds of applications are also possible.

### BACKGROUND ART

To measure electromagnetic radiation, especially in the infrared wavelength region, different photodetector technologies may be employed, making use of different physical processes such as photovoltaic, photoelectric, and photoconductive effects. The photodetectors based on the photoconductive effect are known as photoresistors, photosensitive resistors, photoconductors, or photoconductive detectors. A photodetector comprises at least one photosensitive region, which changes at least one of its physical quantities proportional to electromagnetic radiation. In case of the photoconductors, this physical quantity is the resistance. The photoresistors change their resistance when they are irradiated with electromagnetic radiation in their sensitive spectral range. The change in the resistance value is proportional to the received electromagnetic radiation, which may be physically described as the irradiance, e.g. in the infrared (IR) range. Thus, by measuring the resistance change, the irradiance may be determined.

Each photosensitive region may be described as a “pixel”. For the case that the photodetector has more than one pixel, the pixels may be deposited on a single substrate or they may be deposited on different substrates.

Photodetectors, especially photoresistors, show a strong temperature dependency. Their resistor value changes with the temperature in a comparable scale as with irradiance. Thus, any temperature drift in the resistance value should be corrected for a correct irradiance measurement. There may also be other environmental conditions directly effecting the resistance of photoconductive resistors or the signal output of other detector technologies.

Even with a temperature stabilization of the photodetectors by means of for example thermoelectric cooling (TEC), the photoresistors and other detector technologies show a long-time drift. There are different physical explanations for this drift, such as long living electron-hole pairs, yet there is no solution to suppress it. All the effects contributing to a change in the output signal of the detector except the irradiation itself, which is the physical quantity to be measured, can be collected under the term “dark drift”.

There is a need for improvements with respect to a simple, cost-efficient and reliable photodetectors which can be used, in particular within the infrared (IR) spectral range, for monitoring or investigation purposes, especially for spectroscopy, gas sensing, or concentration measurements. Specifically, photodetectors, which are stabilized by an actively regulated thermoelectric cooling system for measurements requiring high stability, repeatability and accuracy, are costly in price and in system footprint, since they require not only a cooler but also a corresponding electronic driver.

To compensate the dark drift, more than one pixel may be employed. At least one of the pixels may be a “dark” pixel, which means that the photosensitive region is not receiving any optical radiation during the measurement. At least one of the pixels may be an “active pixel”, which is exposed to the measured optical radiation. Thus, the pixels are exposed to the same environmental conditions except the optical radiation, so that all drifts should happen to both pixels in the same way, and the drift of the active pixel can be compensated with the dark pixel.

For the simplicity of the process, in most cases, the dark pixel is covered with a material, such as “black” ink or a “black” glue, which absorbs the radiation. Nevertheless, the absorption of the electromagnetic radiation, especially of the IR radiation leads to a self-heating. Since such materials absorb more energy than the other detectors in the system, the heating of the dark pixel is stronger than the heating of any other active pixel. Further, the active pixels are usually covered by an optical filter to filter only a specific wavelength through, while blocking all others. In most cases, the optical filters are interference filters and thus not absorbing the optical radiation for blocking purposes, so that less heating occurs. Thus, the active and dark pixels are not in thermal equilibrium anymore and the dark drift compensation does not work.

A second issue is the process of applying the dark material. This process is different to all other pixels which is mostly the gluing an optical filter and/or further optical elements such as lenses etc. For the dark pixel, a glue or ink is dispensed on the pixel. This additional process in the manufacturing leads to longer production time and a worse scalability of the whole measurement system. Since the dark material is also in contact with the photosensitive area of the dark pixel, it may cause chemical reactions and may lead to the degradation of the photosensitive region.

U.S. Pat. No. 4,891,519 A describes a turbidimeter for measuring a turbidity of a test liquid including a hollow main body having openings formed at its lower end through which the test liquid is introduced into a measuring optical path within the main body, a semiconductor laser diode arranged in the main body at its upper end and emitting a laser light, a first prism arranged within the main body and guiding the laser light into the measuring optical path, a second prism arranged within the main body and guiding light emanating from the measuring optical path to the upper end of the main body, first and second semiconductor photo-diodes arranged within the main body at its upper end such that the light emanating from the second prism is exclusively made incident upon the first semiconductor photodiode, and first and second operational amplifiers arranged within the main body at its upper end and amplifying output signals supplied from the first and second semiconductor photodiodes, respectively. Output signals generated from the first and second operational amplifiers are supplied to a differential amplifier to derive a difference there between, the difference corresponding to the turbidity of the test liquid. The differential amplifier is arranged remote from the main body.

US 2013/240738 A1 describes an electromagnetic radiation detection device which includes, on a same substrate: at least one active detector of the electromagnetic radiation provided with a first element sensitive to said radiation, at least one reference detector including a second element sensitive to said electromagnetic radiation, and a lid provided with first reflective means reflecting the incident electromagnetic radiation, said lid covering without contact the second sensitive element and defining with the substrate a cavity having the reference detector housed therein.

WO 2006/062809 A2 describes methods for making optically blind reference pixels and systems employing the same. The reference pixels may be configured to be identical to, or substantially identical to, the active detector elements of a focal plane array assembly. The reference pixels may be configured to use the same relatively longer thermal isolation legs as the active detector pixels of the focal plane, thus eliminating joule heating differences. An optically blocking structure may be placed in close proximity directly over the reference pixels.

KR 102 164 930 B1 describes a blind cell having a reflective plate structure, a microbolometer including the same, and a method of manufacturing the same.

### Problem to be Solved

It is therefore desirable to provide devices and methods facing the above-mentioned technical challenges of known devices and methods. Specifically, it is an object of the present invention to provide precise, low cost and consumer friendly devices and methods for performing optical measurements with a reliable integrated calibration, specifically a self-calibration against detector drifts without user involvement.

### SUMMARY

This problem is addressed by the invention with the features of the independent claims. Advantageous embodiments which might be realized in an isolated fashion or in any arbitrary combinations are listed in the dependent claims as well as throughout the specification.

In a first aspect of the present invention, a photodetector for measuring optical radiation is disclosed.

The term “photodetector” as used herein is a broad term and is to be given its ordinary and customary meaning to a person of ordinary skill in the art and is not to be limited to a special or customized meaning. The term specifically may refer, without limitation, to an optical sensor configured for detecting optical radiation, such as for detecting an illumination and/or a light spot generated by at least one light beam. The photodetector may comprise at least one substrate. As an example, a single photodetector may be a substrate with at least one single photosensitive region, which generates a physical response to the illumination for a given wavelength range. Specifically, the photodetector may comprise a plurality of photosensitive regions, e.g. for different wavelength regions and/or for calibration purposes. As will be outlined in further detail below, the photodetector may specifically be subdivided into a plurality of pixels.

The term “optical radiation” as used herein is a broad term and is to be given its ordinary and customary meaning to a person of ordinary skill in the art and is not to be limited to a special or customized meaning. The term specifically may refer, without limitation, to electromagnetic radiation in one or more of the visible spectral range, the ultraviolet spectral range and the infrared spectral range. The term “ultraviolet spectral range”, as used herein is a broad term and is to be given its ordinary and customary meaning to a person of ordinary skill in the art and is not to be limited to a special or customized meaning. The term specifically may refer, without limitation, to electromagnetic radiation having a wavelength of 1 nm to 380 nm, preferably of 100 nm to 380 nm. Further, in partial accordance with standard ISO-21348 in a valid version at the date of this document, the term “visible spectral range”, as used herein is a broad term and is to be given its ordinary and customary meaning to a person of ordinary skill in the art and is not to be limited to a special or customized meaning. The term specifically may refer, without limitation, to a spectral range of 380 nm to 760 nm. Further, the term “infrared spectral range” is a broad term and is to be given its ordinary and customary meaning to a person of ordinary skill in the art and is not to be limited to a special or customized meaning. The term specifically may refer, without limitation, to electromagnetic radiation in the range of 760 nm to 1000 μm, wherein the range of 760 nm to 1.5 μm is usually denominated as “near infrared spectral range” (NIR) while the range from 1.5μ to 15 μm is denoted as “mid infrared spectral range” (MidIR) and the range from 15 μm to 1000 μm as “far infrared spectral range” (FIR). Preferably, the optical radiation used for the typical purposes of the present invention is optical radiation in the infrared (IR) spectral range, more preferred, in the near infrared (NIR) and the mid infrared spectral range (MidIR), especially the optical radiation having a wavelength of 1 μm to 5 μm, preferably of 1 μm to 3 μm.

The photodetector comprises:
at least one active pixel comprising an active photosensitive region, wherein the active pixel is configured for generating at least one active signal by using the active photosensitive region, wherein the active signal is dependent on an illumination of the active pixel by the optical radiation; and
at least one dark pixel comprising:
   a dark photosensitive region, wherein the dark pixel is configured for generating at least one dark signal by using the dark photosensitive region, wherein the dark signal is independent on an illumination of the dark pixel by the optical radiation; and
   a temperature equalizing cover configured for covering the dark photosensitive region at least against the optical radiation.

The term “photosensitive region” as used herein is a broad term and is to be given its ordinary and customary meaning to a person of ordinary skill in the art and is not to be limited to a special or customized meaning. The term specifically may refer, without limitation, to a spatial area or volume, which is configured for generating at least one electrical response to incident optical radiation, specifically a photocurrent by using the photoelectric effect as the skilled person will understand. The photosensitive region may comprise at least one photosensitive material, specifically at least one semiconductor.

The term “pixel” as used herein is a broad term and is to be given its ordinary and customary meaning to a person of ordinary skill in the art and is not to be limited to a special or customized meaning. The term specifically may refer, without limitation, to an optoelectronic unit of the photodetector comprising at least one photosensitive region and optionally further elements, specifically optical elements and/or electronic elements and/or optoelectronic elements. The pixel may be configured for generating at least one signal, e.g. an electrical signal which is dependent on an illumination of the photosensitive region by optical radiation. The pixel may be configured for generating further signals, specifically signals which may be dependent on ambient conditions of the pixel such as an ambient temperature. The pixel may be an optical sensor or at least a portion of an optical sensor, which is configured for operating essentially autonomously as a part of the photodetector. The pixel may be referred to as a sub-photodetector and may be configured for performing a specific task such as detecting optical radiation in at least one specific wavelength range and/or at least assisting a calibration. The pixel comprises a photosensitive region, which may be sensitive within at least one predetermined wavelength range, and the pixel is configured for generating at least one signal by using the photosensitive region. As the skilled person will know, free charge carriers may also spontaneously form in an unilluminated semiconductor, specifically thermally induced. Thus, also without illumination, the photosensitive region may still generate a measurable signal, a so called dark signal, specifically a dark current.

The pixel may be an active pixel or a dark pixel. The term “active pixel” as used herein is a broad term and is to be given its ordinary and customary meaning to a person of ordinary skill in the art and is not to be limited to a special or customized meaning. The term specifically may refer, without limitation, to a pixel comprising an illuminable photosensitive region referred to as active photosensitive region here. In other words, the active pixel may be arranged such that, when the active pixel is illuminated by optical radiation, the active photosensitive region is illuminable by at least a portion of the optical radiation. The portion of the optical radiation may specifically be within a sensitive wavelength range of the active photosensitive region. The active pixel may specifically be free of elements blocking the optical radiation, specifically at least within the sensitive wavelength range of the active photosensitive region. The active pixel may be configured such that it is exposed to the optical radiation. Thus, the active pixel may specifically be configured for actively detecting the optical radiation, at least within a predetermined wavelength range. Generally, for a better overview, entities referring to the active pixel are indicated here by using the prefix “active” such as in active photosensitive region and in active signal.

As said, the active signal is dependent on an illumination of the active pixel by the optical radiation. The active signal may specifically comprise a photocurrent generated by the photosensitive region upon illumination. The active signal may be directly proportional to an intensity of the optical radiation. The term “dependent on an illumination” as used herein is a broad term and is to be given its ordinary and customary meaning to a person of ordinary skill in the art and is not to be limited to a special or customized meaning. The term specifically may refer, without limitation, to the fact that the active signal is generated upon exposure of the active photosensitive region to optical radiation. The active signal may be predominantly dependent on the illumination of the active photosensitive region of the active pixel. However, the active signal may further be dependent on intrinsic properties of the active pixel itself, specifically of the active photosensitive region, e.g. on a material of the active photosensitive region. The active signal may further be dependent on further environmental conditions of the active pixel, specifically on a temperature of the active pixel, more specifically on a temperature of the active photosensitive region. However, an impact of the illumination of the active pixel may specifically be a major contribution or more specifically a dominant contribution to the active signal.

The term “dark pixel” as used herein is a broad term and is to be given its ordinary and customary meaning to a person of ordinary skill in the art and is not to be limited to a special or customized meaning. The term specifically may refer, without limitation, to a pixel comprising a photosensitive region shielded from optical radiation. The dark pixel may be designed such that the dark photosensitive region is non-illuminable, at least within a sensitive wavelength range of the dark photosensitive region. The dark photosensitive region may be configured and/or arranged within the dark pixel for not receiving the optical radiation, specifically at least not within a sensitive wavelength range of the dark photosensitive region. Specifically, as will be outlined in further detail below, the dark pixel may comprise at least one element configured for blocking the optical radiation, specifically at least within the sensitive wavelength range of the dark photosensitive region. Generally, for a better overview, entities referring to the dark pixel are indicated here by using the prefix “dark” such as in dark photosensitive region and in dark signal.

The photodetector's active pixel may change its resistance when irradiated with electromagnetic radiation in its sensitive spectral range. For example, for PbS, the sensitive spectral range may be from 1 μm to 3 μm. For example, for PbSe, the sensitive spectral range may be from 1 μm to 5 μm. The change in the resistance may be proportional to the received electromagnetic radiation, which may be physically described as the irradiance in the IR-range. Thus, by measuring the resistance change, the irradiance may be determined by using the active pixel. However, the one or more active pixels of the photodetector, especially the photoresistors, show a strong temperature dependency. Their resistor value can change with the temperature in a comparable scale as with irradiance. Thus, any temperature drift in the resistance value should be corrected for a correct irradiance measurement. Moreover, there may be other environmental conditions directly effecting the resistance of photoconductive resistors and/or the active signal. Known techniques use a temperature stabilization of the detectors by means of for example thermoelectric cooling (TEC). But even if this technique is used, the photoresistors show a long-time drift. There are different physical explanations for this drift, such as long living electron-hole pairs, yet there is no solution to suppress it. All these effects contributing to a change in the active signal except the irradiation itself, which is the real physical quantity to be measured, can be collected under “dark drift” henceforth.

The present invention proposes to compensate the dark drift by using a photodetector having more than one pixel. At least one of the pixels is designed as a “dark” pixel, which means that the photosensitive area of said pixel does not receive any irradiation during a measurement, while at least one of the pixels is an “active pixel”, which is exposed to the optical radiation during measurement. The active and the dark pixel may be designed such that, assuming the exposition of all environmental conditions to the active and the dark pixels except the radiation, all other drifts happen to both active and dark pixels in the same way, and the drift of the active pixel can be compensated with the dark pixel.

The dark pixel is configured for generating the dark signal independent on an illumination of the dark pixel by the optical radiation. The term “independent on an illumination” as used herein is a broad term and is to be given its ordinary and customary meaning to a person of ordinary skill in the art and is not to be limited to a special or customized meaning. The term specifically may refer, without limitation, to the fact that the dark pixel may be configured for generating the dark signal without optical radiation reaching and/or entering the dark photosensitive region, in particular optical radiation in a wavelength range in which the dark photosensitive region may be sensitive. Specifically, the term “independent on an illumination” may refer to the fact that an illumination of the dark pixel may not affect the dark signal. As an example, a high intensity illumination of the dark pixel may lead to the same dark signal as a low intensity illumination of the dark pixel. As a further example, an illumination of the dark pixel in different wavelength ranges may lead to the same dark signal. The dark pixel may be configured for generating the dark signal without being illuminated. The dark signal may depend on properties of the dark pixel itself, specifically of the dark photosensitive region itself, e.g. on a material of the dark photosensitive region. The dark signal may specifically depend on environmental conditions apart from an illumination of the dark pixel, specifically on a temperature of the dark pixel, more specifically on a temperature of the dark photosensitive region. The dark signal may be a measure of the dark drift. The dark signal may specifically comprise a dark current.

The dark signal may specifically be relevant for performing a calibration. For this purpose, the dark pixel and specifically the dark signal may be utilized. Since the dark photosensitive region may not be illuminated by the optical radiation, variations in the dark signal may result from the dark drift of the dark pixel, which may consecutively be transferred to a drift of the active pixel. For a simple transfer, the dark pixel and the active pixel may, apart from the temperature equalizing cover, at least be of similar, specifically of identical kind, specifically regarding the dark photosensitive region and the active photosensitive region. As an example, the dark photosensitive region and the active photosensitive region may comprise the same material. This may specifically ensure that drifts of the active pixel and drifts of the dark pixel occur in the same way.

The dark pixel comprises a temperature equalizing cover configured for covering the dark photosensitive region at least against the optical radiation. The term “cover” including any grammatical variation thereof as used herein is a broad term and is to be given its ordinary and customary meaning to a person of ordinary skill in the art and is not to be limited to a special or customized meaning. The term specifically may refer, without limitation, to a mechanical structure configured for at least partially encapsulating and/or enveloping and/or surrounding an object, in the present case specifically the dark photosensitive region. Thus, the temperature equalizing cover may be configured for optically shielding the dark photosensitive region. The temperature equalizing cover may be configured for blocking the optical radiation, specifically at least within a sensitive wavelength range of the dark photosensitive region. The dark pixel and specifically the temperature equalizing cover may be illuminated by the optical radiation, but the dark photosensitive region may still be unilluminated due to being covered by the temperature equalizing cover. In other words, the optical radiation may illuminate the dark pixel, but still not the dark photosensitive region, because it does not reach and/or enter the dark photosensitive region due to the temperature equalizing cover. The dark signal is independent on an illumination of the dark pixel by the optical radiation specifically by means of the temperature equalizing cover. The temperature equalizing cover may be arranged direct onto the photosensitive region e.g. as a coating.

The temperature equalizing cover may comprise a material which has a minimum transmissivity, specifically at least for the sensitive wavelength range of the dark photosensitive region. The temperature equalizing cover may have, at least in a sensitive spectral range of the dark photosensitive region, a transmittance of less than 5%, specifically of less than 3%, more specifically of less than 1%. The temperature equalizing cover may have, at least in a sensitive spectral range of the dark photosensitive region, an optical density of less than 10% which may also be referred to as OD1, specifically of less than 1% which may also be referred to as OD2, more specifically of less than 0.1% which may also be referred to as OD3. Generally, the optical density ODn is given by the formula ODn=10⁻ⁿ, wherein n is an integer. Thus, as an example, OD1=10⁻¹=0.1=10%. This may allow to avoid optical radiation on the dark photosensitive region. Instead of the term “spectral range”, the term “wavelength range” may be used synonymously.

The temperature equalizing cover may be configured for decoupling the dark photosensitive region from its environment mechanically, specifically from mechanical forces and/or particles, e.g. contaminations. In other words, the temperature equalizing cover may also be configured for protecting the dark photosensitive region against its environment.

The temperature equalizing cover may be configured for equalizing heat input on the active pixel and the dark pixel. The temperature equalizing cover may be configured for relating the active pixel and the dark pixel. Specifically, the temperature equalizing cover may be configured for relating a temperature of the active pixel and a temperature of the dark pixel. Thus, the temperature of the active pixel and the temperature of the dark pixel may be affected equally by environmental conditions. This may allow to avoid different thermal behavior between the active pixel and the dark pixel. The temperature equalizing cover may be configured for equalizing the heat input as equal as possible, e.g. within tolerances of less than 5%, specifically 3%, more specifically 1%. Other tolerances may be feasible and may specifically be depended on a specific application. As the dark resistance, photosensitivity and time constant of photodetectors such as PbS or PbSe detectors vary with change of the temperature, the proposed temperature equalizing cover is extremely helpful to keep the setup of each individual pixel as close as possible. This may allow exposing each pixel of the photodetector to the same amount of radiation which then results in a more uniform temperature distribution in the sensor system and hence a more uniform detector performance. The term “temperature equalizing” as used herein is a broad term and is to be given its ordinary and customary meaning to a person of ordinary skill in the art and is not to be limited to a special or customized meaning. The term specifically may refer, without limitation, to influencing the heat input onto the dark photosensitive region.

The term “temperature equalizing cover” as used herein is a broad term and is to be given its ordinary and customary meaning to a person of ordinary skill in the art and is not to be limited to a special or customized meaning. The term specifically may refer, without limitation, to a cover configured for equalizing heat input on the active pixel and the dark pixel. The temperature equalizing cover may be designed as a non-absorbing cover. The temperature equalizing cover may be made from at least one low-absorbing material, in particular from at least one non-absorbing material. As the skilled person will know, an illumination of an object with optical radiation, specifically with infrared radiation, will generally result in a temperature increase of the object due to an absorption of the optical radiation. In other words, the absorption of the optical radiation generally leads to a self-heating of the object. The temperature equalizing cover may be or may comprise a cover having a low absorption, wherein the cover is preferably non-absorbing, specifically in the infrared spectral range. The temperature equalizing cover may be configured for absorbing a minimum optical radiation. The temperature equalizing cover may be or may comprise a non-absorbing cover. Specifically, the temperature equalizing cover may comprise a non-absorbing material. The temperature equalizing cover may have, at least in a spectral range of the optical radiation, an absorption of less than 5%, specifically of less than 3%, more specifically of less than 1%. Such a low absorption can generally be realized in different ways. The temperature equalizing cover may be configured for at least predominantly reflecting the optical radiation. The temperature equalizing cover may have, at least in a spectral range of the optical radiation, a reflectance of more than 95%, specifically of more than 97%, more specifically of more than 99%. The temperature equalizing cover may be made of at least one material having a minimum transmissivity. Every material with a low transmissivity, specifically in a sensitive wavelength range of the dark photosensitive region, in combination with a low absorbance may be used for the temperature equalizing cover. The temperature equalizing cover may comprise at least one material selected from the group consisting of: a metal, specifically gold, sliver and/or aluminum; a reflecting coating; a reflective foil; a crystal; a semiconductor. Further materials may be feasible. Combinations of two or more different materials may be feasible.

The dark pixel may comprise a coating arranged on or as part of the temperature equalizing cover. The coating may comprise a carbon filled plastic material.

The term “absorption” including any grammatical variations thereof, as used herein is a broad term and is to be given its ordinary and customary meaning to a person of ordinary skill in the art and is not to be limited to a special or customized meaning. The term specifically may refer, without limitation, to an extinction of optical radiation at an object, specifically due to a consumption of an energy of the optical radiation within the object. At the object, the optical radiation may e.g. induce a self-heating or a generation of free charge carries. Thus, absorbed optical radiation may specifically not be transmitted through the object and/or reflected by the object. The absorption of the object, e.g. of the temperature equalizing cover or of a photosensitive region, may be wavelength dependent. The term “absorption” may also be referred to as “absorbance”. Specifically, absorption properties of an object may be referred to as absorbance of the object.

The term “reflection” including any grammatical variations thereof as used herein is a broad term and is to be given its ordinary and customary meaning to a person of ordinary skill in the art and is not to be limited to a special or customized meaning. The term specifically may refer, without limitation, to a change in direction of a wave front of optical radiation at an interface between two different optical media, wherein the wave front is returned into the optical medium from which it originated. The reflection may comprise specular reflection, also denoted as regular reflection. The reflection may comprise diffuse reflection, wherein the incident optical radiation is back scattered at the interface into a plurality of different directions. The reflection of the object, e.g. of the temperature equalizing cover, may be wavelength dependent. The term “reflection” may also be referred to as “reflectance”. Specifically, reflection properties of an object may be referred to as reflectance of the object.

The term “transmission” including any grammatical variations thereof as used herein is a broad term and is to be given its ordinary and customary meaning to a person of ordinary skill in the art and is not to be limited to a special or customized meaning. The term specifically may refer, without limitation, to optical radiation going through an object, specifically unobstructed. The transmission of the object, e.g. the temperature equalizing cover, may be wavelength dependent. The term “transmission” may also be referred to as “transmittance”. Specifically, transmission properties of an object may be referred to as transmittance of the object or as optical density of the object.

The term “optical density” as used herein is a broad term and is to be given its ordinary and customary meaning to a person of ordinary skill in the art and is not to be limited to a special or customized meaning. The term specifically may refer, without limitation, to a property of a device or a material describing how much optical radiation can pass or can go through the device or the material. Specifically, with regard to an optical filter, the optical density may describe how much optical radiation can pass the optical filter in a blocking range of the optical filter. As already indicated, the optical density ODn is generally given by the formula ODn=10⁻ⁿ, wherein n is an integer. Thus, as an example, OD1=10⁻¹=0.1=10%.

The temperature equalizing cover may be configured for maintaining its temperature stable, specifically when being illuminated by the optical radiation. As said, the temperature equalizing cover may specifically be configured for encapsulating the dark photosensitive region. Thus, by maintaining its temperature stable, the temperature equalizing cover may be configured for further maintaining a temperature of the dark photosensitive region stable. This again may particularly be important for performing a calibration. For an optimal calibration of the active pixel, as addressed above, the active pixel should generally be exposed to the same environmental conditions, specifically to the same temperature, as the dark pixel, as the skilled person will understand. Thus, maintaining a temperature of the dark photosensitive region stable and/or at the temperature of the active photosensitive region may be particularly beneficial for performing the calibration.

The temperature equalizing cover may be configured for maintaining a temperature of the dark photosensitive region stable within a temperature range from −30° C. to 90° C., specifically from 10° C. to 30° C., more specifically from 15° C. to 25° C. As an example, the dark photosensitive region may comprise lead sulfide (PbS) and the temperature equalizing cover may be configured for maintaining a temperature of the dark photosensitive region stable within a temperature range from −30° C. to 70° C. As a further example, the dark photosensitive region may comprise lead selenide (PbSe) and the temperature equalizing cover may be configured for maintaining a temperature of the dark photosensitive region stable within a temperature range from −30° C. to 90° C. The temperature equalizing cover may be configured for suppressing a temperature change, specifically a temperature increase, of the dark photosensitive region of more than 1° C., specifically of more than 0.5° C., more specifically of more than 0.1° C. The dark photosensitive region and the active photosensitive region should be in a thermal equilibrium for an optimal calibration. The temperature equalizing cover may be configured for maintaining a temperature of the dark photosensitive region at a temperature of the active photosensitive region within a temperature range from −30° C. to 90° C., specifically from 10° C. to 30° C., more specifically from 15° C. to 25° C. The temperature equalizing cover may be configured for maintaining a temperature difference between the active photosensitive region and the dark photosensitive region of less than 1° C., specifically of less than 0.5° C., more specifically of less than 0.1° C.

A mechanical setup of active and dark pixels may be as similar as possible. The dark pixel may comprise similar elements compared to the active pixel and/or may comprise elements mimicking the elements of the active pixel. For example, the active pixel may have at least one optical element such as at least one optical filter. The temperature equalizing cover may comprise one or more of glass or other optical substrates with identical dimensions to the optical filters.

The temperature equalizing cover may comprise at least one of an optical filter, specifically an interference filter; an optical reflector, specifically at least one of a metal coated substrate and a Bragg reflector. The substrate may be a planar substrate. The substrate may specifically be a smooth substrate. The substrate may specifically be a glass substrate. The term “optical filter” as used herein is a broad term and is to be given its ordinary and customary meaning to a person of ordinary skill in the art and is not to be limited to a special or customized meaning. The term specifically may refer, without limitation, to an optical element which is configured for blocking at least a portion of incident optical radiation in at least one predetermined wavelength range. In other words, the optical filter may be configured for blocking a predetermined wavelength range which may also be referred to as blocking range. The optical filter may be configured for reflecting the incident optical radiation in at least one predefined wavelength range. Thus, the reflected optical radiation may not be absorbed by the optical filter and induce self-heating and it may not be transmitted to the dark photosensitive region. The optical filter may be configured for transmitting the incident optical radiation in at least one predefined wavelength range, specifically in a wavelength range, in which the dark photosensitive region is not sensitive or at least almost not sensitive. Thus, the transmitted incident optical radiation may not induce a signal of the dark photosensitive region and it may also not lead to a self-heating of the optical filter due to an absorption. As an example, the optical filter may be or may comprise at least one optical long pass filter having a cut-on wavelength which is above the sensitive spectral range of the dark photosensitive region. The optical filter may comprise at least one of an optical long pass filter, an optical short pass filter and an optical bandpass filter. In practice, a wavelength in the blocking range may also be transmitted, however, with a considerably lower intensity, such as at most 1%, specifically at most 0.1%, more specifically at most 0.01% compared to a wavelength outside the blocking range of the optical filter. The optical filter may have an optical density in the blocking range of less than 1% which may also be referred to as OD2, specifically of less than 0.1% which may also be referred to as OD3.

In general, the characteristic wavelength range of the optical filter, in which the portion of the incident light which is selectively reflected, can be characterized by a peak wavelength and a full width at half maximum (FWHM). Herein, the term “peak wavelength” as used herein is a broad term and is to be given its ordinary and customary meaning to a person of ordinary skill in the art and is not to be limited to a special or customized meaning. The term specifically may refer, without limitation, to a wavelength of the optical bandpass filter which provides maximal reflection to the incident light. In general, the peak wavelength can assume any wavelength which is covered by optical radiation, however, wavelengths of 100 nm to 5 μm, especially of 1 μm to 3 μm, are preferred. This wavelength range is, typically, denoted by the terms “near infrared radiation” or “NIR radiation”. Further, the term “full width at half maximum” (FWHM) as used herein is a broad term and is to be given its ordinary and customary meaning to a person of ordinary skill in the art and is not to be limited to a special or customized meaning. The term specifically may refer, without limitation, to a wavelength range which provides 50% of the maximal reflection to the incident light. In general, the full width half maximum may assume any reasonable value with respect to a portion of the characteristic wavelength range, wherein values of 200 nm to 300 nm may be preferred. However, further values for the full width half maximum may also be feasible, such as 5 nm to 10 nm for high selectivity. Herein, a transition between maximal reflection at the peak wavelength and minimal transmission in the blocking range can assume, in general, any form, such as a sharp transition over a small wavelength range, or a gradual transition over a larger wavelength range.

The optical filter may comprise at least one interference filter. The term “interference filter” as used herein is a broad term and is to be given its ordinary and customary meaning to a person of ordinary skill in the art and is not to be limited to a special or customized meaning. The term specifically may refer, without limitation, to an optical filter comprising a plurality of thin films having different refractive indices. The thin films may for instance comprise dielectric materials and/or metallic materials and/or semiconductors such as silicon or germanium. The thin films may typically have film thicknesses in the nm range or in the μm range. The interference filter may comprise at least one substrate. The thin films may be stacked one the substrate. Different kinds of interference filters are generally known to the skilled person. The interference filter may be configured for splitting an incident light beam at at least one interface of the thin films, e.g. for reflecting a first portion of the light beam while transmitting a second portion of the light beam. The thin films may be configured and/or arranged such that an interference of the splitted light beams results in a transmission of optical radiation of a predetermined wavelength range through the interference filter. Other kinds of optical filters may also be feasible. As an example, the optical filter may also comprise at last one monochromator.

The term “optical reflector” as used herein is a broad term and is to be given its ordinary and customary meaning to a person of ordinary skill in the art and is not to be limited to a special or customized meaning. The term specifically may refer, without limitation, to an in optical element configured for reflecting optical radiation, at least in a predetermined wavelength range. Thus, the optical reflector may comprise at least one material having a high reflectivity such as a metal. The optical reflector may be or may comprise at least one mirror. The optical reflector may comprise at least one of a metal coated glass substrate and a Bragg reflector. The term “Bragg reflector” as used herein is a broad term and is to be given its ordinary and customary meaning to a person of ordinary skill in the art and is not to be limited to a special or customized meaning. The term specifically may refer, without limitation, to an optical reflector comprising a plurality of thin films, specifically alternating dielectric thin films with different refractive indices and/or film thicknesses. Different kinds of Bragg reflectors are generally known to the skilled person. The Bragg reflector may be configured for reflecting at least a portion of incident optical radiation at each interface of the thin films in such way that the reflected portions of the incident optical radiation interfere constructively. Other kinds of optical reflectors may also be feasible.

For example, the temperature equalizing cover may comprise at least one optical filter. The active pixel may also comprise at least one optical filter, such that the active pixel is designated for detecting optical radiation of at least one predetermined wavelength range, e.g. for spectroscopic applications. The active pixel may comprise at least one optical filter arranged in a beam path of the optical radiation before the active photosensitive region. The optical filter of the active pixel and the temperature equalizing cover of the dark pixel may have identical geometries, at least up to tolerances of 5%, specifically 3%, more specifically 1%. Other tolerances may be feasible and may specifically be depended on a specific application. This may specifically be beneficial for manufacturing of the photodetector according to the present invention, specifically for upscaling a production of the photodetector. It may for instance allow using an automated pick and place system in a production line. The temperature equalizing cover may comprise at least one optical filter which is of the same kind as the optical filter arranged in the beam path of the optical radiation before the active photosensitive region. This may even further facilitate manufacturing. Generally, the more similar an architecture of the dark pixel is to an architecture of the active pixel, the more a production of the photodetector may be facilitated, since less different processes may have to be performed, wherein different processes may usually have to be performed by using different equipment. This may generally save time and resources.

The active photosensitive region and the dark photosensitive region may be of the same kind. Specifically, the active photosensitive region and the dark photosensitive region may comprise identical materials. This may again facilitate production and specifically also calibration. As outlined further above, for an optimal transfer of a drift of the dark pixel to a drift of the active pixel, it may generally be beneficial that both active and dark pixels and specifically both photosensitive regions are as similar as possible. In addition to the better performance, there are also multiple advantages from an assembly point of view. The method according to the present invention may allow to use the same machines and processes for the dark pixel that are used for the installation of the optical filters on adjacent active pixels. That means that an already established production process simply needs to be run one more time for the dark pixel, instead of developing a very different process with additional production steps that has possibly to be run on a different machine. Performing two different processes also is in general more time consuming both for small scale manufacturing and for high scale production lines than running the same process an additional time.

The active photosensitive region and the dark photosensitive region may have a sensitive spectral range from 0.1 μm to 10 μm, specifically from 0.5 μm to 5 μm, more specifically from 1 μm to 3 μm. The sensitive spectral range of the active photosensitive region and the sensitive spectral range of the dark photosensitive region may be identical, at least up to tolerances of 5%, specifically 3%, more specifically 1%. However, in principle, the sensitive spectral range of the active photosensitive region and the sensitive spectral range of the dark photosensitive region may also be different. As an example, the active photosensitive region and the dark photosensitive region may comprise different materials. However, the active photosensitive region and the dark photosensitive region may specifically comprise identical materials, specifically for facilitating calibration as explained above.

The active photosensitive region and the dark photosensitive region may comprise at least one photoconductive material, in particular the identical photoconductive material. The photoconductive material may be selected from at least one of lead sulfide (PbS); lead selenide (PbSe). However, other embodiments of the photosensitive regions may also be feasible.

The photodetector may further comprise at least one substrate. The active photosensitive region and the dark photosensitive region may be assembled on the same substrate. The active photosensitive region and the dark photosensitive region may be assembled on the substrate in a lateral distance from edge to edge of less than 1 mm, specifically of less than 0.5 mm, more specifically of less than 0.25 mm. Keeping individual pixels as close together as possible may generally facilitate exposing each pixel to the same amount of optical radiation which may again result in a uniform temperature distribution over the photodetector. This may once more facilitate calibration and moreover a general performance of the photodetector. However, the active photosensitive region and the dark photosensitive region may also be assembled on different substrates. The term “substrate” as used herein is a broad term and is to be given its ordinary and customary meaning to a person of ordinary skill in the art and is not to be limited to a special or customized meaning. The term specifically may refer, without limitation, to a mechanical support element or a combination of mechanical support elements configured for supporting at least one further element. As an example, the substrate may be at least one planar substrate having at least one planar, in particular smooth, surface. As a further example, the substrate may be a plate-shaped or disk-shaped substrate, with two opposing surfaces, in particular planar surfaces. The substrate may typically have a thickness in the range of 0.5 mm, more specifically in the range of 0.2 mm. However, other embodiments of the substrate are also feasible.

The photodetector may further comprise at least one fixture attached to the substrate. The fixture may be configured for holding the temperature equalizing cover. The fixture may optionally be configured for holding the optical filter arranged in the beam path of the optical radiation before the active photosensitive region. The fixture may generally facilitate mechanically holding the temperature equalizing cover and/or the addressed optical filter in place. The term “fixture” as used herein is a broad term and is to be given its ordinary and customary meaning to a person of ordinary skill in the art and is not to be limited to a special or customized meaning. The term specifically may refer, without limitation, to a mechanical carrier element or a combination of mechanical carrier elements configured for holding at least one further element. The fixture may be configured for holding the temperature equalizing cover above the dark photosensitive region, specifically without direct contact between the temperature equalizing cover and the dark photosensitive region. The fixture may be configured for holding the temperature equalizing cover at at least one edge of the temperature equalizing cover. The fixture may be configured for holding the addressed optical filter above the active photosensitive region, specifically without direct contact between the optical filter and the active photosensitive region. The fixture may be configured for holding the addressed optical filter at at least one edge of the optical filter. The fixture may be configured for holding the temperature equalizing cover and the addressed optical filter at the same height, up to tolerances of less than 5%, specifically less than 3%, more specifically less than 1%. By using the fixture, a direct contact of the dark photosensitive region and the temperature equalizing cover as well as a direct contact of the active photosensitive region and the addressed optical filter may be avoided. Such a direct contact may generally cause chemical reactions in the photosensitive region and thus lead to a degradation of the photosensitive region.

The active photosensitive region and the dark photosensitive region may be arranged spatially separated. The temperature equalizing cover may be configured for at least partially encapsulating and/or enveloping and/or surrounding the dark photosensitive region. However, the temperature equalizing cover may not cover the active photosensitive region, thereby constituting different rooms or spaces for the active photosensitive region and the dark photosensitive region. The temperature equalizing cover may constitute a space for the dark photosensitive region, in particular different from a space of the active photosensitive region. In addition, to the temperature equalizing cover, the dark photosensitive region may be arranged within a housing, e.g. together with the active photosensitive region. In known configurations without a cover but a combined housing for both only, e.g. as described in U.S. Pat. No. 4,891,519 A, multiple reflections may occur which lead to illumination even of the dark pixel. The propose temperature equalizing cover may allow ensuring that the dark photosensitive region is completely shielded from illumination.

In a further aspect of the present invention, a spectral measurement device for spectrally analyzing optical radiation provided by at least one measurement object is disclosed. The term “spectrum” including any grammatical variation thereof, as used herein is a broad term and is to be given its ordinary and customary meaning to a person of ordinary skill in the art and is not to be limited to a special or customized meaning. The term specifically may refer, without limitation, to a partition of the optical wavelength range. A spectrum may be constituted by an optical signal defined by a signal wavelength and a corresponding signal intensity. Specifically, the spectrum may comprise spectral information relating to the measurement object, e.g. to a type and/or a composition of at least one material forming the measurement object, which can be determined by recording at least one spectrum related to the measurement object.

Consequently, the term “spectral measurement device”, as used herein is a broad term and is to be given its ordinary and customary meaning to a person of ordinary skill in the art and is not to be limited to a special or customized meaning. The term specifically may refer, without limitation, to an apparatus which is configured for determining spectral information by recording at least one measured value for at least one signal intensity related to at least one corresponding signal wavelength of optical radiation and by evaluating at least one detector signal which relates to the signal intensity. Specifically, the spectral measurement device may be, may comprise or may be part of at least one miniaturized apparatus. For example, the spectral measurement device may be, may comprise or may be part of at least one handheld apparatus. The term “handheld” as used herein is a broad term and is to be given its ordinary and customary meaning to a person of ordinary skill in the art and is not to be limited to a special or customized meaning. The term specifically may refer, without limitation, to an arbitrary portable apparatus. The handheld apparatus may specifically be configured, by its dimensions and/or its weight, for being carried by a user with a single hand. Thus, as an example, a volume of the handheld apparatus may not exceed 0.001 m³, and/or the weight of the handheld apparatus may not exceed 1 kg. Specifically, the spectral measurement device may be, may comprise or may be part of at least one wearable device, specifically a smartphone or a smartwatch. The fact that the spectral measurement device may be, may comprise of may be part of a miniaturized apparatus such as a handheld apparatus may specifically facilitate a consumer friendly application of the spectral measurement device. Further, the spectral measurement device may comprise at least one housing. The housing may be configured for protecting and/or shielding parts inside the housing against environmental influences such as mechanical influences or electromagnetic influences.

The term “spectrally analyzing”, as used herein is a broad term and is to be given its ordinary and customary meaning to a person of ordinary skill in the art and is not to be limited to a special or customized meaning. The term specifically may refer, without limitation, to measuring optical radiation, specifically an intensity of the optical radiation, in a wavelength dependent fashion. As indicated above, spectrally analyzing may specifically comprise determining spectral information by recording at least one measured value for at least one signal intensity related to at least one corresponding signal wavelength of optical radiation and by evaluating at least one detector signal which relates to the signal intensity.

The optical radiation is provided by at least one measurement object. In this context, the term “providing” including any grammatical variations thereof as used herein is a broad term and is to be given its ordinary and customary meaning to a person of ordinary skill in the art and is not to be limited to a special or customized meaning. The term specifically may refer, without limitation, to at least one of reflecting, specifically diffusely; diffracting; transmitting and emitting optical radiation. The optical radiation provided by the measurement object may be indicative of at least one of a physical property of the measurement object, e.g. an optical property and/or a temperature of the measurement object, and a chemical property of the measurement object, e.g. a chemical composition of the measurement object. As an example, the optical radiation provided by the measurement object may be emitted by the measurement object, specifically at least partially towards the spectral measurement device. Further, the optical radiation provided by the measurement object may be reflected by the measurement object at least partially towards the spectral measurement device, specifically diffusely. Further, the optical radiation provided by the measurement object may be transmitted through the measurement object at least partially towards the spectral measurement device. However, the measurement object may also at least partially absorb the optical radiation, which may specifically be indicative of at least one physical property of the measurement object and/or at least one chemical property of the measurement object such as a chemical composition of at least one material forming the measurement object.

The term “measurement object” as used herein is a broad term and is to be given its ordinary and customary meaning to a person of ordinary skill in the art and is not to be limited to a special or customized meaning. The term specifically may refer, without limitation, to an arbitrary body, chosen from a living body and a non-living body. The measurement object may specifically comprise at least one material which may be subject to an investigation by the spectral measurement device. The measurement object may generally refer to an object which is to be measured, e.g. for which a spectrum is to be recorded, wherein the object has in principle arbitrary properties, e.g. arbitrary optical properties and/or an arbitrary shape. The measurement object may comprise at least one solid sample and/or at least one fluid. However, other measurement objects may also be feasible.

The spectral measurement device comprises:
at least one photodetector according to any one of the embodiments referring to a photodetector disclosed above or below in further detail;
at least one radiation source configured for emitting optical radiation at least partially towards the measurement object; and
at least one evaluation unit configured for
   performing a calibration of the spectral measurement device by using the dark signal; and
   generating at least one item of spectral information related to the measurement object by using the active signal.

The term “radiation source” as used herein is a broad term and is to be given its ordinary and customary meaning to a person of ordinary skill in the art and is not to be limited to a special or customized meaning. The term specifically may refer, without limitation, to an in principle arbitrary device configured for emitting optical radiation. The radiation source may be configured for emitting optical radiation in a spectral range from 0.1 μm to 10 μm, specifically from 0.25 μm to 5 μm, more specifically from 0.5 μm to 1 μm. Specifically, for PbS used as photosensitive region, the radiation source may be configured for emitting optical radiation in a spectral range from 1 μm to 3 μm. Specifically, for PbSe used as photosensitive region, the radiation source may be configured for emitting optical radiation in a spectral range from 1 μm to 5 μm. The term “emitting” including any grammatical variations thereof as used herein is a broad term and is to be given its ordinary and customary meaning to a person of ordinary skill in the art and is not to be limited to a special or customized meaning. The term specifically may refer, without limitation, to an arbitrary process of generating and sending out optical radiation. The radiation source may comprise at least one of a thermal radiator and a semiconductor-based radiation source. The semiconductor-based radiation source may be selected from at least one of a light emitting diode (LED) and a laser, specifically a laser diode. The thermal radiator may comprise at least one incandescent lamp.

The radiation source may be modulated. The term “modulating” including any grammatical variation thereof is a broad term and is to be given its ordinary and customary meaning to a person of ordinary skill in the art and is not limited to a special or customized meaning. The term specifically may refer, without limitation, to the process of changing, specifically periodically changing, at least one property of optical radiation, specifically one or both of an intensity or a phase of the optical radiation. The modulation may be a full modulation from a maximum value to zero, or may be a partial modulation, from a maximum value to an intermediate value greater than zero. The radiation source may be modulated electrically and/or mechanically and/or electromechanically. As an example, the radiation source may be modulated by using at least one chopper.

The term “evaluation unit” as used herein is a broad term and is to be given its ordinary and customary meaning to a person of ordinary skill in the art and is not to be limited to a special or customized meaning. The term specifically may refer, without limitation, to an arbitrary device adapted to perform the named operations, preferably by using at least one data processing device and, more preferably, by using at least one processor and/or at least one application-specific integrated circuit. As an example, the at least one evaluation unit may comprise at least one data processing device having a software code stored thereon comprising a number of computer commands. The evaluation unit may provide one or more hardware elements for performing one or more of the named operations and/or may provide one or more processors with software running thereon for performing one or more of the named operations. As an example, the evaluation unit may comprise one or more programmable devices such as one or more computers, application-specific integrated circuits (ASICs), Digital Signal Processors (DSPs), or Field Programmable Gate Arrays (FPGAs) which are configured to perform the evaluation. Additionally or alternatively, however, the evaluation unit may also fully or partially be embodied by hardware. The evaluation unit may further be configured for controlling the spectral measurement device or parts thereof. The evaluation unit may specifically be configured for performing at least one measurement cycle in which a plurality of signals may be picked up. The information as determined by the evaluation unit may be provided to at least one of a further apparatus and/or to a user, specifically in at least one of an electronic, visual, acoustic, or tactile fashion. The information as determined by the evaluation unit may be stored in the memory storage and/or in a separate storage device and/or may be passed on via at least one interface, such as a wireless interface and/or a wire-bound interface.

Thus, the evaluation unit may further comprise at least one interface configured for providing the item of spectral information to at least one of a user and an external device. The evaluation unit may further be configured for at least partially controlling the spectral measurement device. Specifically, the evaluation unit may be configured for controlling at least one of the radiation source and the photodetector. The evaluation unit may at least partially be comprised by at least one electronic communication unit. The electronic communication unit may comprise at least one of a smartphone, a tablet and a stand-alone controller with a display. As an example, the spectral measurement device may comprise a handheld apparatus, which may be controlled by using a smartphone and/or a tablet. Specifically, an app on the smartphone and/or the tablet may be used for sending operation commands to the spectral measurement device and further for receiving and displaying the item of spectral information and/or further information related to the spectral measurement device.

The term “item of spectral information” as used herein is a broad term and is to be given its ordinary and customary meaning to a person of ordinary skill in the art and is not to be limited to a special or customized meaning. The term specifically may refer, without limitation, to knowledge or evidence providing a qualitative and/or quantitative description relating to at least one spectral analysis, specifically of at least one measurement object. The item of spectral information may comprise at least one of a physical property of the measurement object and a chemical property of the measurement object, specifically a chemical composition of the measurement object. The physical property may specifically comprise an optical property such at least one absorbance of the measurement object and/or at least one emissivity of the measurement object. The chemical composition may specifically refer to qualitative and/or quantitative information on at least one material the measurement object comprises.

As said, the evaluation unit is specifically also configured for performing a calibration of the spectral measurement device by using the dark signal. The term “calibration” including any grammatical variation thereof as used herein is a broad term and is to be given its ordinary and customary meaning to a person of ordinary skill in the art and is not to be limited to a special or customized meaning. The term specifically may refer, without limitation, to a process of correcting, at least from time to time, drifting effects that may occur, in practice, in the spectral measurement device or in parts of the spectral measurement device, specifically the photodetector. The drifting effects may primarily be caused by alterations related to the spectral measurement device itself or by alterations having an effect onto the spectral measurement device. The alterations may, especially, comprise at least one of: a degradation of at least one of the radiation source and the photodetector; a temperature drift of at least one of the radiation source and the photodetector; a variation of an ambient temperature affecting the spectral measurement device; a variation of a temperature related to the spectral measurement device, i.e. the temperature at which the photodetector and corresponding electronics may operate; a mechanical extension or contraction of at least one component as comprised by the spectral measurement device, especially of at least one of a mechanical housing, a holder and an optical element. However, further alterations may also be feasible. Further, electrochemical processes or physical processes such as a relaxation of long lifespan traps may lead to drifting effects. As an example, a temperature drift may affect both the active pixel and the dark pixel, specifically equally, whereas a relaxation of long lifespan traps may affect only the active pixel. The temperature equalizing cover may generally facilitate distinguishing between drifting effects which are dependent on an illumination and drifting effects which are independent on an illumination. Correcting the drifting effects may particularly facilitate maintaining a reliability of measurement data, specifically the item of spectral information, specifically by avoiding that the drifting effects may distort the measurement data to such an extent that results as determined by the spectral measurement device may become inconclusive.

The calibration may comprise at least one of compensating a temperature drift; compensating a long-time drift. The term “drift” as used herein is a broad term and is to be given its ordinary and customary meaning to a person of ordinary skill in the art and is not to be limited to a special or customized meaning. The term specifically may refer, without limitation, to a variation or shifting of at least one entity, specifically a signal or a device used for generating the signal, over time, specifically over longer time scales such as hours or days or even longer. The variations may specifically be larger than a usual noise of the signal. As an example, the photodetector may drift over time, wherein at least one signal, e.g. the dark signal, may vary, although it should be stable, apart from usual noise, since the dark photosensitive region may not be illuminated. The drift of the dark signal or the dark pixel, respectively, may than be transferred to the active pixel for calibration. The drift may have different causes, e.g. temperature variations.

The term “temperature drift” as used herein is a broad term and is to be given its ordinary and customary meaning to a person of ordinary skill in the art and is not to be limited to a special or customized meaning. The term specifically may refer, without limitation, to a drift caused by temperature variations, specifically of the spectral measurement device or at least parts of the spectral measurement device. The temperature variations may again be caused by operation conditions of the spectral measurement device or by environmental conditions of the spectral measurement device, e.g. an illumination or ambient temperature variations. Generally, as the skilled person will know, photodetectors, specifically photoconductors, may be temperature dependent, i.e. the generated signals may vary with varying temperature, which should be corrected for a reliable measurement of optical radiation.

Further, even with stable temperatures, photodetectors may generally show a long-time drift. An explanation for this phenomenon may be long living electron-hole pairs. The term “long-time drift” as used herein is a broad term and is to be given its ordinary and customary meaning to a person of ordinary skill in the art and is not to be limited to a special or customized meaning. The term specifically may refer, without limitation, to a drift over longer time scales, specifically hours or days or even longer, which is independent of variations relating to the spectral measurement device, specifically temperature variations. The long-time drift may specifically be or comprise at least one unpreventable intrinsic drift of the spectral measurement device or of parts of the spectral measurement device, specifically of the photodetector, more specifically the photosensitive region, i.e. the active photosensitive region and/or the dark photosensitive region.

The calibration may comprise compensating the drifts for reliable measurements. The term “compensation” including any grammatical variation thereof as used herein is a broad term and is to be given its ordinary and customary meaning to a person of ordinary skill in the art and is not to be limited to a special or customized meaning. The term specifically may refer, without limitation, to a correction of at least one drift by identifying the drift and making up for the drift. As an example, a drift of a signal in one direction may be identified, e.g. a continuous decrease of the signal. Then, when processing the measured signal, the measured signal may be reset to its original value before the drift. In particular, a drift may be identified by using the dark pixel, specifically by evaluating the dark signal, specifically over time. A drift of the active pixel may then be compensated by using this information. In other words, the evaluation unit may specifically be configured for performing a calibration of the active pixel, specifically of the active signal, by using the dark signal. More specifically, the evaluation unit may be configured for compensating a temperature drift of the active pixel, specifically of the active signal, wherein the temperature drift may be identified by using the dark signal. Additionally or alternatively, the evaluation unit may be configured for compensating a long-time drift of the active pixel, specifically of the active signal, wherein the long-time drift may be identified by using the dark signal.

In a further aspect of the present invention, a method for spectrally analyzing optical radiation provided by at least one measurement object is disclosed. The method is performed by using at least one spectral measurement device according to any one of the embodiments referring to a spectral measurement device disclosed above or below in further detail. The method comprises the following steps:
a) emitting optical radiation at least partially towards the measurement object by using the radiation source;
b) generating at least one dark signal by using the dark pixel, wherein the dark signal is independent on an illumination of the dark pixel by the optical radiation provided by the measurement object;
c) performing a calibration of the spectral measurement device by using the evaluation unit for evaluating the dark signal;
d) generating at least one active signal by using the active pixel, wherein the active signal is dependent on an illumination of the active pixel by the optical radiation provided by the measurement object; and
e) generating at least one item of spectral information related to the measurement object by using the evaluation unit for evaluating the active signal.

The method steps may be performed in the given order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion. For further definitions and embodiments of the method it may be referred to the definitions and embodiments of the spectral measurement device and the photodetector. Specifically, as outlined above, the calibration may comprise at least one of compensating a temperature drift; compensating a long-time drift.

The method for spectrally analyzing optical radiation provided by at least one measurement object may at least partially be computer implemented. Specifically, one or more of the method steps may be performed by using a computer or computer network, more specifically by using a computer program. Thus, generally, any of the method steps including provision and/or manipulation of data may be performed by using a computer or computer network. Generally, these method steps may include any of the method steps, typically except for method steps requiring manual work, such as providing the measurement object and/or certain aspects of performing the actual measurements.

In a further aspect of the present invention, a use of a photodetectors according to any one of the embodiments disclosed above or below in further detail referring to a spectral measurement device is proposed, for a purpose of use selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; and a textiles identification and/or recycling application.

The devices and methods according to the present invention may provide a large number of advantages over known devices and methods. First of all, applying a dark pixel may generally allow a calibration of the device resulting in more reliable measurements. Further on, applying a temperature equalizing cover for covering the dark pixel may facilitate a reliable calibration of the device. The calibration may be performed without user involvement increasing consumer friendliness of the device. Further, the calibration may be realized with low cost measures. By applying the temperature equalizing cover, there may be no more need for applying external temperature compensation elements such as Peltier elements, which would also require additional electronics. Further, reproducibility and mass production are facilitated, specifically for the case that the optical filter of the active pixel and the temperature equalizing cover of the dark pixel may have identical geometries or the case that both may even be identical optical filters. Such measures may allow for using an automated pick and place system in a production line and for reducing the number of different production processes in the production line. This may generally save production time and resources.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A photodetector for measuring optical radiation, the photodetector comprising:
at least one active pixel comprising an active photosensitive region, wherein the active pixel is configured for generating at least one active signal by using the active photosensitive region, wherein the active signal is dependent on an illumination of the active pixel by the optical radiation; and
at least one dark pixel comprising:
   a dark photosensitive region, wherein the dark pixel is configured for generating at least one dark signal by using the dark photosensitive region, wherein the dark signal is independent on an illumination of the dark pixel by the optical radiation; and
   a temperature equalizing cover configured for covering the dark photosensitive region at least against the optical radiation.

Embodiment 2: The photodetector according to the preceding embodiment, wherein the temperature equalizing cover is configured for equalizing heat input on the active pixel and the dark pixel.

Embodiment 3: The photodetector according to any one of the preceding embodiment, wherein the temperature equalizing cover is configured for maintaining a temperature of the dark photosensitive region stable within a temperature range from −30° C. to 90° C., specifically from 10° C. to 30° C., more specifically from 15° C. to 25° C.

Embodiment 4: The photodetector according to any one of the preceding embodiments, wherein the temperature equalizing cover is configured for suppressing a temperature change, specifically a temperature increase, of the dark photosensitive region of more than 1° C., specifically of more than 0.5° C., more specifically of more than 0.1° C.

Embodiment 5: The photodetector according to any one of the preceding embodiments, wherein the temperature equalizing cover is configured for maintaining a temperature of the dark photosensitive region at a temperature of the active photosensitive region within a temperature range from −30° C. to 90° C., specifically from 10° C. to 30° C., more specifically from 15° C. to 25° C.

Embodiment 6: The photodetector according to any one of the preceding embodiments, wherein the temperature equalizing cover is configured for maintaining a temperature difference between the active photosensitive region and the dark photosensitive region of less than 1° C., specifically of less than 0.5° C., more specifically of less than 0.1° C.

Embodiment 7: The photodetector according to any one of the preceding embodiments, wherein the temperature equalizing cover has, at least in a spectral range of the optical radiation, an absorption of less than 5%, specifically of less than 3%, more specifically of less than 1%.

Embodiment 8: The photodetector according to any one of the preceding embodiments, wherein the temperature equalizing cover has, at least in a spectral range of the optical radiation, a reflectance of more than 95%, specifically of more than 97%, more specifically of more than 99%.

Embodiment 9: The photodetector according to any one of the preceding embodiments, wherein the temperature equalizing cover has, at least in a sensitive spectral range of the dark photosensitive region, a transmittance of less than 5%, specifically of less than 3%, more specifically of less than 1%.

Embodiment 10: The photodetector according to any one of the preceding embodiments, wherein the temperature equalizing cover comprises at least one of an optical filter, specifically an interference filter; an optical reflector, specifically at least one of a metal coated substrate and a Bragg reflector.

Embodiment 11: The photodetector according to any one of the preceding embodiments, wherein the active pixel comprises at least one optical filter arranged in a beam path of the optical radiation before the active photosensitive region, wherein the optical filter and the temperature equalizing cover have identical geometries, at least up to tolerances of 5%, specifically 3%, more specifically 1%.

Embodiment 12: The photodetector according to the preceding embodiments, wherein the temperature equalizing cover comprises at least one optical filter which is of the same kind as the optical filter arranged in the beam path of the optical radiation before the active photosensitive region.

Embodiment 13: The photodetector according to any one of the preceding embodiments, wherein the active photosensitive region and dark photosensitive region are of the same kind.

Embodiment 14: The photodetector according to any one of the preceding embodiments, wherein at least one of the active photosensitive region and the dark photosensitive region has a sensitive spectral range from 0.1 μm to 10 μm, specifically from 0.5 μm to 5 μm, more specifically from 1 μm to 3 μm.

Embodiment 15: The photodetector according to any one of the preceding embodiments, wherein the active photosensitive region and the dark photosensitive region comprise at least one photoconductive material, in particular an identical photoconductive material.

Embodiment 16: The photodetector according to the preceding embodiment, wherein the photoconductive material is selected from at least one of PbS; PbSe.

Embodiment 17: The photodetector according to any one of the preceding embodiments, further comprising at least one substrate, wherein the active photosensitive region and the dark photosensitive region are assembled on the substrate.

Embodiment 18: The photodetector according to the preceding embodiment, wherein the active photosensitive region and the dark photosensitive region are assembled on the substrate in a lateral distance from edge to edge of less than 1 mm, specifically of less than 0.5 mm, more specifically of less than 0.25 mm.

Embodiment 19: The photodetector according to any one of the two preceding embodiments, further comprising at least one fixture attached to the substrate, wherein the fixture is configured for holding the temperature equalizing cover and optionally the optical filter arranged in the beam path of the optical radiation before the active photosensitive region.

Embodiment 20: A spectral measurement device for spectrally analyzing optical radiation provided by at least one measurement object, the spectral measurement device comprising:
at least one photodetector according to any one of the preceding embodiments;
at least one radiation source configured for emitting optical radiation at least partially towards the measurement object; and
at least one evaluation unit configured for
   performing a calibration of the spectral measurement device by using the dark signal; and
   generating at least one item of spectral information related to the measurement object by using the active signal.

Embodiment 21: The spectral measurement device according to the preceding embodiment, wherein the calibration comprises at least one of compensating a temperature drift; compensating a long-time drift.

Embodiment 22: The spectral measurement device according to any one of the preceding embodiments referring to a spectral measurement device, wherein the radiation source comprises at least one of a thermal radiator and a semiconductor-based radiation source, wherein the semiconductor-based radiation source comprises at least one of a light emitting diode (LED) and a laser.

Embodiment 23: The spectral measurement device according to any one of the preceding embodiments referring to a spectral measurement device, wherein the radiation source is configured for emitting optical radiation in a spectral range from 0.1 μm to 10 μm, specifically from 0.25 μm to 5 μm, more specifically from 0.5 μm to 1 μm.

Embodiment 24: The spectral measurement device according to any one of the preceding embodiments referring to a spectral measurement device, wherein the evaluation unit is further configured for at least partially controlling the spectral measurement device.

Embodiment 25: The spectral measurement device according to any one of the preceding embodiments referring to a spectral measurement device, wherein the evaluation unit further comprises at least one interface configured for providing the item of spectral information to at least one of a user and an external device.

Embodiment 26: The spectral measurement device according to any one of the preceding embodiments referring to a spectral measurement device, wherein the evaluation unit is at least partially comprised by at least one electronic communication unit.

Embodiment 27: The spectral measurement device according to the preceding embodiment, wherein the electronic communication unit comprises at least one of a smartphone, a tablet and a stand-alone controller with a display.

Embodiment 28: A method for spectrally analyzing optical radiation provided by at least one measurement object by using at least one spectral measurement device according to any one of the preceding embodiments referring to a spectral measurement device, the method comprising:
a) emitting optical radiation at least partially towards the measurement object by using the radiation source;
b) generating at least one dark signal by using the dark pixel, wherein the dark signal is independent on an illumination of the dark pixel by the optical radiation provided by the measurement object;
c) performing a calibration of the spectral measurement device by using the evaluation unit for evaluating the dark signal;
d) generating at least one active signal by using the active pixel, wherein the active signal is dependent on an illumination of the active pixel by the optical radiation provided by the measurement object; and
e) generating at least one item of spectral information related to the measurement object by using the evaluation unit for evaluating the active signal.

Embodiment 29: The method according to the preceding embodiment, wherein the calibration comprises at least one of compensating a temperature drift; compensating a long-time drift.

Embodiment 30: The method according to anyone of the preceding method embodiments, wherein the method is at least partially computer-implemented.

Embodiment 31: A use of a photodetector according to any one of the preceding embodiments referring to a photodetector, for a purpose of use, selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a an exemplary embodiment of a photodetector according to the present invention; and

FIG. 2 shows an exemplary embodiment of a spectral measurement device according to the present invention in a highly schematic fashion; and

FIG. 3 shows a flow chart of an exemplary embodiment of a method for spectrally analyzing optical radiation according to the present invention.

### DETAILED DESCRIPTION OF THE EMBODIMENTS

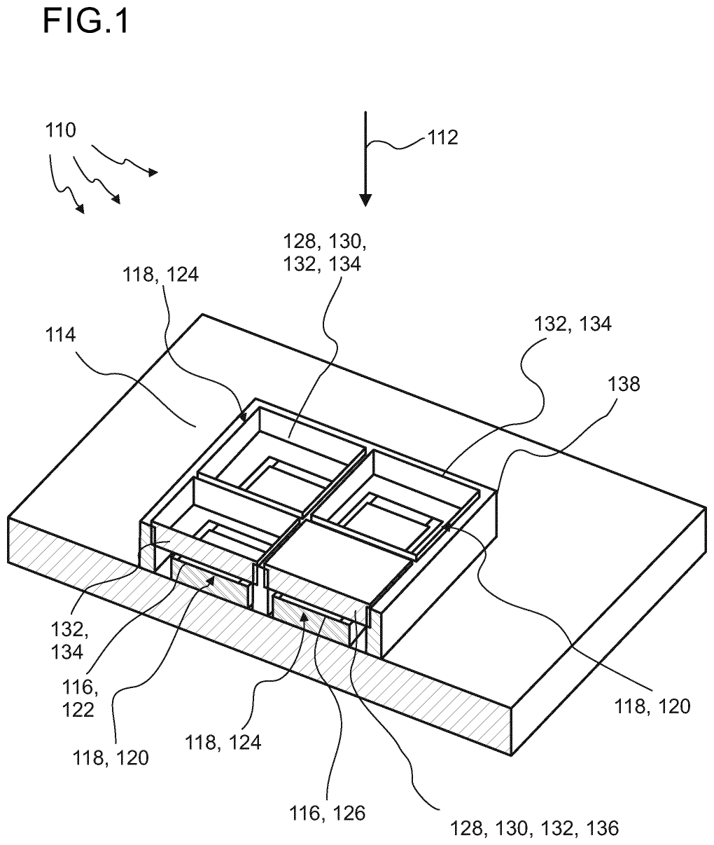

FIG. 1 shows an exemplary embodiment of a photodetector 110 for measuring optical radiation 112. The photodetector 110 may comprise at least one substrate 114. The photodetector 110 may be an optical sensor configured for detecting the optical radiation 112, such as for detecting an illumination and/or a light spot generated by at least one light beam. The photodetector may comprise a substrate 114 with at least one photosensitive region 116, which generates a physical response to an illumination by the optical radiation 112 for a given wavelength range. Specifically, the photodetector 110 may comprise a plurality of photosensitive regions 116, e.g. for different wavelength regions and/or for calibration purposes. The photosensitive region 116 may be a spatial area or volume, which is configured for generating at least one electrical response to the optical radiation 112, specifically a photocurrent by using the photoelectric effect as the skilled person will understand. The photosensitive region 116 may comprise at least one photosensitive material, specifically at least one semiconductor.

The photodetector 110 may specifically be subdivided into a plurality of pixels 118. The pixel 118 may be an optoelectronic unit of the photodetector comprising the photosensitive region 116 and optionally further elements, specifically optical elements and/or electronic elements and/or optoelectronic elements. The pixel 118 may be configured for generating at least one signal, e.g. an electrical signal which is dependent on an illumination of the photosensitive region 116 by the optical radiation 112. The pixel 118 may be configured for generating further signals, specifically signals which may be dependent on ambient conditions of the pixel 118 such as an ambient temperature. The pixel 118 may be an optical sensor or at least a portion of an optical sensor, which is configured for operating essentially autonomously as a part of the photodetector 110. The pixel 118 may be referred to as a sub-photodetector and may be configured for performing a specific task such as detecting the optical radiation 112 in at least one specific wavelength range and/or at least assisting a calibration. The pixel 118 comprises a photosensitive region 116, which may be sensitive within at least one predetermined wavelength range, and the pixel 118 is configured for generating at least one signal by using the photosensitive region 116. As the skilled person will know, free charge carriers may also spontaneously form in an unilluminated semiconductor, specifically thermally induced. Thus, also without illumination, the photosensitive region 116 may still generate a measurable signal, a so called dark signal, specifically a dark current.

The pixel 118 may be an active pixel 120. The photodetector 110 comprises at least one active pixel 120. The active pixel 120 comprises an active photosensitive region 122. The active pixel 120 is configured for generating at least one active signal by using the active photosensitive region 122. The active signal is dependent on an illumination of the active pixel 120 by the optical radiation 112. The active pixel 120 may be a pixel 118 comprising an illuminable photosensitive region 116 referred to as active photosensitive region 122 here. The active pixel 120 may be arranged such that, when the active pixel 120 is illuminated by the optical radiation 112, the active photosensitive region 122 is illuminable by at least a portion of the optical radiation 112. The portion of the optical radiation 112 may specifically be within a sensitive wavelength range of the active photosensitive region 122. The active pixel 120 may specifically be free of elements blocking the optical radiation, specifically at least within the sensitive wavelength range of the active photosensitive region 122. The active pixel 118 may be configured such that it is exposed to the optical radiation 112. Thus, the active pixel 118 may specifically be configured for actively detecting the optical radiation 112, at least within a predetermined wavelength range.

As said, the active signal is dependent on an illumination of the active pixel 120 by the optical radiation 112. The active signal may specifically comprise a photocurrent generated by the photosensitive region upon illumination. The active signal may be directly proportional to an intensity of the optical radiation 112. The active signal may be generated upon exposure of the active photosensitive region 122 to the optical radiation 112. The active signal may be predominantly dependent on the illumination of the active photosensitive region 122 of the active pixel 120. However, the active signal may further be dependent on intrinsic properties of the active pixel 120 itself, specifically of the active photosensitive region 122, e.g. on a material of the active photosensitive region 122. The active signal may further be dependent on further environmental conditions of the active pixel 120, specifically on a temperature of the active pixel 120, more specifically on a temperature of the active photosensitive region 122. However, an impact of the illumination of the active pixel 118 may specifically be a major contribution or more specifically a dominant contribution to the active signal.

The pixel 118 may be a dark pixel. The photodetector 110 comprises at least one dark pixel 124. The dark pixel 124 comprises at dark photosensitive region 124. The dark pixel 124 is configured for generating at least one dark signal by using the dark photosensitive region 126. The dark signal is independent on an illumination of the dark pixel 124 by the optical radiation 112. The dark pixel 124 comprises a temperature equalizing cover 128. The temperature equalizing cover 128 is configured for covering the dark photosensitive region 126 at least against the optical radiation 112. The dark pixel 124 may be a pixel 118 comprising a photosensitive region 116 shielded from the optical radiation 112. The dark pixel 124 may be designed such that the dark photosensitive region 126 is non-illuminable, at least within a sensitive wavelength range of the dark photosensitive region 126. The dark photosensitive region 126 may be configured and/or arranged within the dark pixel 124 for not receiving the optical radiation 112, specifically at least not within a sensitive wavelength range of the dark photosensitive region 126. Specifically, as will be outlined in further detail below, the dark pixel 124 may comprise at least one element configured for blocking the optical radiation 112, specifically at least within the sensitive wavelength range of the dark photosensitive region 126.

As said, the dark pixel 124 is configured for generating the dark signal independent on an illumination of the dark pixel 124 by the optical radiation 112. The dark pixel 124 may be configured for generating the dark signal without the optical radiation 112 reaching and/or entering the dark photosensitive region 126, in particular in a wavelength range in which the dark photosensitive region 126 may be sensitive. Specifically, an illumination of the dark pixel 124 may not affect the dark signal. A high intensity illumination of the dark pixel 124 may lead to the same dark signal as a low intensity illumination of the dark pixel 124. An illumination of the dark pixel 124 in different wavelength ranges may lead to the same dark signal. The dark pixel 124 may be configured for generating the dark signal without being illuminated. The dark signal may depend on properties of the dark pixel 124 itself, specifically of the dark photosensitive region 126 itself, e.g. on a material of the dark photosensitive region 126. The dark signal may specifically depend on environmental conditions apart from an illumination of the dark pixel 124, specifically on a temperature of the dark pixel 124, more specifically on a temperature of the dark photosensitive region 126. The dark signal may be a measure of the dark drift. The dark signal may specifically comprise a dark current.

The dark signal may specifically be relevant for performing a calibration. For this purpose, the dark pixel and specifically the dark signal may be utilized. Since the dark photosensitive region 126 may not be illuminated by the optical radiation 112, variations in the dark signal may result from the dark drift of the dark pixel 124, which may consecutively be transferred to a drift of the active pixel 120. For a simple transfer, the dark pixel 124 and the active pixel 120 may, apart from the temperature equalizing cover 128, at least be of similar, specifically of identical kind, specifically regarding the dark photosensitive region 126 and the active photosensitive region 122. The dark photosensitive region 126 and the active photosensitive region 122 may comprise the same material. This may specifically ensure that drifts of the active pixel 120 and drifts of the dark pixel 124 occur in the same way.

As said, the dark pixel 124 comprises a temperature equalizing cover 128 configured for covering the dark photosensitive region 126 at least against the optical radiation 112. The temperature equalizing cover 128 may be a mechanical structure configured for at least partially encapsulating and/or enveloping and/or surrounding an object, in the present case specifically the dark photosensitive region 126. Thus, the temperature equalizing cover 126 may be configured for optically shielding the dark photosensitive region 126. The temperature equalizing cover 128 may be configured for blocking the optical radiation 112, specifically at least within a sensitive wavelength range of the dark photosensitive region 126. The dark pixel 124 and specifically the temperature equalizing cover 128 may be illuminated by the optical radiation 112, but the dark photosensitive region 126 may still be unilluminated due to being covered by the temperature equalizing cover 128. In other words, the optical radiation 112 may illuminate the dark pixel 124, but still not the dark photosensitive region 126, because it does not reach and/or enter the dark photosensitive region 126 due to the temperature equalizing cover 128. The dark signal is independent on an illumination of the dark pixel 124 by the optical radiation 112 specifically by means of the temperature equalizing cover 128.

The temperature equalizing cover 128 may comprise a material which has a minimum transmissivity, specifically at least for the sensitive wavelength range of the dark photosensitive region 126. The temperature equalizing cover 128 may have, at least in a sensitive spectral range of the dark photosensitive region 126, a transmittance of less than 5%, specifically of less than 3%, more specifically of less than 1%. The temperature equalizing cover 128 may have, at least in a sensitive spectral range of the dark photosensitive region 126, an optical density of less than 10% which may also be referred to as OD1, specifically of less than 1% which may also be referred to as OD2, more specifically of less than 0.1% which may also be referred to as OD3. This may allow to avoid the optical radiation 112 on the dark photosensitive region 126.

The temperature equalizing cover 128 may be configured for decoupling the dark photosensitive region 126 from its environment mechanically, specifically from mechanical forces and/or particles, e.g. contaminations. In other words, the temperature equalizing cover 128 may also be configured for protecting the dark photosensitive region 126 against its environment.

The temperature equalizing cover 128 may be configured for equalizing heat input on the active pixel 120 and the dark pixel 124. This may allow to avoid different thermal behavior between the active pixel 120 and the dark pixel 124. The temperature equalizing cover 128 may be configured for equalizing the heat input as equal as possible, e.g. within tolerances of less than 5%, specifically 3%, more specifically 1%.

The temperature equalizing cover 128 may be configured for influencing the heat input onto the dark photosensitive region 126. The temperature equalizing cover 128 may be configured for equalizing heat input on the active pixel 120 and the dark pixel 124. The temperature equalizing cover 128 may be designed as a non-absorbing cover 130. In other words, the temperature equalizing cover 128 may be or may comprise a non-absorbing cover 130. The temperature equalizing cover 128 may be made from at least one low-absorbing material, in particular from at least one non-absorbing material. The temperature equalizing cover 128 may be or may comprise a cover having a low absorption, wherein the cover is preferably non-absorbing, specifically in the infrared spectral range. The temperature equalizing cover 128 may be configured for absorbing a minimum optical radiation. The temperature equalizing cover 128 may have, at least in a spectral range of the optical radiation 112, an absorption of less than 5%, specifically of less than 3%, more specifically of less than 1%. Such a low absorption can generally be realized in different ways. The temperature equalizing cover 128 may be configured for at least predominantly reflecting the optical radiation 112. The temperature equalizing cover 128 may have, at least in a spectral range of the optical radiation, a reflectance of more than 95%, specifically of more than 97%, more specifically of more than 99%. The temperature equalizing cover 128 may be made of at least one material having a minimum transmissivity. Every material with a low transmissivity, specifically in a sensitive wavelength range of the dark photosensitive region 126, in combination with a low absorbance may be used for the temperature equalizing cover 128. The temperature equalizing cover 128 may comprise at least one material selected from the group consisting of: a metal, specifically gold, silver and/or aluminum; a reflecting coating; a reflective foil; a crystal; a semiconductor. Further materials may be feasible. Combinations of two or more different materials may be feasible.

The temperature equalizing cover 128 may be configured for maintaining its temperature stable, specifically when being illuminated by the optical radiation 112. As said, the temperature equalizing cover 128 may specifically be configured for encapsulating the dark photosensitive region 126. Thus, by maintaining its temperature stable, the temperature equalizing cover 128 may be configured for further maintaining a temperature of the dark photosensitive region 126 stable. This again may particularly be important for performing a calibration. For an optimal calibration of the active pixel, as addressed above, the active pixel 120 should generally be exposed to the same environmental conditions, specifically to the same temperature, as the dark pixel 124. Thus, maintaining a temperature of the dark photosensitive region stable 126 and/or at the temperature of the active photosensitive region 122 may be particularly beneficial for performing the calibration.

The temperature equalizing cover 128 may be configured for maintaining a temperature of the dark photosensitive region 126 stable within a temperature range from −30° C. to 90° C., specifically from 10° C. to 30° C., more specifically from 15° C. to 25° C. As an example, the dark photosensitive region 126 may comprise lead sulfide (PbS) and the temperature equalizing cover 128 may be configured for maintaining a temperature of the dark photosensitive region 126 stable within a temperature range from −30° C. to 70° C. As a further example, the dark photosensitive region 126 may comprise lead selenide (PbSe) and the temperature equalizing cover 128 may be configured for maintaining a temperature of the dark photosensitive region 126 stable within a temperature range from −30° C. to 90° C. The temperature equalizing cover 128 may be configured for suppressing a temperature change, specifically a temperature increase, of the dark photosensitive region 126 of more than 1° C., specifically of more than 0.5° C., more specifically of more than 0.1° C. The dark photosensitive region 126 and the active photosensitive region 122 should be in a thermal equilibrium for an optimal calibration. The temperature equalizing cover 128 may be configured for maintaining a temperature of the dark photosensitive region 126 at a temperature of the active photosensitive region 122 within a temperature range from −30° C. to 90° C., specifically from 10° C. to 30° C., more specifically from 15° C. to 25° C. The temperature equalizing cover 128 may be configured for maintaining a temperature difference between the active photosensitive region 122 and the dark photosensitive region 126 of less than 1° C., specifically of less than 0.5° C., more specifically of less than 0.1° C.

A mechanical setup of the active pixel 120 and dark pixel 124 may be as similar as possible. The dark pixel 124 may comprise similar elements compared to the active pixel 120 and/or may comprise elements mimicking the elements of the active pixel 120. The active pixel 120 may have at least one optical element 132 such as at least one optical filter 134. The temperature equalizing cover 128 may comprise one or more of glass or other optical substrates with identical dimensions to the optical filters 134.

The temperature equalizing cover 128 may comprise at least one of an optical filter 134, specifically an interference filter; an optical reflector 136, specifically at least one of a metal coated substrate and a Bragg reflector. In the exemplary embodiment shown in FIG. 1, the photodetector 110 comprises four pixels 118 in total. The two front pixels 118 are shown in a cross-sectional view. The left front pixel 118 is an active pixel 120. The right front pixel 118 is a dark pixel 124 comprising an optical reflector 136 as temperature equalizing cover 128. Further shown in FIG. 1, at the back left pixel 118, is an optical filter 134 being used as temperature equalizing cover 128. The optical filters 134 may be configured for blocking different wavelength ranges of the optical radiation 112, such that at least one optical filter 134 may be usable as temperature equalizing cover 128.

The optical filter 134 may be an optical element 132 configured for blocking at least a portion of the incident optical radiation 112 in at least one predetermined wavelength range. In other words, the optical filter 134 may be configured for blocking a predetermined wavelength range which may also be referred to as blocking range. The optical filter 134 may be configured for reflecting the incident optical radiation 112 in at least one predefined wavelength range. Thus, the reflected optical radiation 112 may not be absorbed by the optical filter 134 and induce self-heating and it may not be transmitted to the dark photosensitive region 126. The optical filter 134 may be configured for transmitting the incident optical radiation 112 in at least one predefined wavelength range, specifically in a wavelength range, in which the dark photosensitive region 126 is not sensitive or at least almost not sensitive. Thus, the transmitted incident optical radiation 112 may not induce a signal of the dark photosensitive region 126 and it may also not lead to a self-heating of the optical filter due to an absorption. The optical filter 134 may be or may comprise at least one optical long pass filter having a cut-on wavelength which is above the sensitive spectral range of the dark photosensitive region. The optical filter 134 may comprise at least one of an optical long pass filter, an optical short pass filter and an optical bandpass filter. In practice, a wavelength in the blocking range may also be transmitted, however, with a considerably lower intensity, such as at most 5%, specifically at most 3%, more specifically at most 1% compared to a wavelength outside the blocking range of the optical filter 134.

As said, the optical filter 134 may comprise at least one interference filter. The interference filter may comprise a plurality of thin films having different refractive indices. The thin films may for instance comprise dielectric materials and/or metallic materials. The thin films may typically have film thicknesses in the nm range or in the μm range. The interference filter may comprise at least one substrate. The thin films may be stacked one the substrate. Different kinds of interference filters are generally known to the skilled person. The interference filter may be configured for splitting an incident light beam at at least one interface of the thin films, e.g. for reflecting a first portion of the light beam while transmitting a second portion of the light beam. The thin films may be configured and/or arranged such that an interference of the splitted light beams results in a transmission of optical radiation of a predetermined wavelength range through the interference filter. Other kinds of optical filters may also be feasible. As an example, the optical filter may also comprise at last one monochromator.

As said, the temperature equalizing cover 128 may specifically comprise at least one optical reflector 136. The optical reflector 136 may be an optical element 132 configured for reflecting the optical radiation 112, at least in a predetermined wavelength range. Thus, the optical reflector 136 may comprise at least one material having a high reflectivity such as a metal. The optical reflector 136 may be or may comprise at least one mirror. The optical reflector 136 may comprise at least one of a metal coated glass substrate and a Bragg reflector. The Bragg reflector may comprise plurality of thin films, specifically alternating dielectric thin films with different refractive indices and/or film thicknesses. Different kinds of Bragg reflectors are generally known to the skilled person. The Bragg reflector may be configured for reflecting at least a portion of the incident optical radiation 112 at each interface of the thin films in such way that the reflected portions of the incident optical radiation interfere constructively. Other kinds of optical reflectors may also be feasible such as a polished material, specifically a metal, or a smooth substrates with a metal coating.

The optical filter 134 of the active pixel 120 and the temperature equalizing cover 128 of the dark pixel 124 may have identical geometries, at least up to tolerances of 5%, specifically 3%, more specifically 1%. As indicated but not shown in the specific exemplary embodiment of FIG. 1, the temperature equalizing cover 128 may comprise at least one optical filter 134 which is of the same kind as the optical filter 134 arranged in the beam path of the optical radiation 112 before the active photosensitive region 122. The active photosensitive region 122 and the dark photosensitive region 126 may be of the same kind. Specifically, the active photosensitive 122 region and the dark photosensitive region 126 may comprise identical materials. The active photosensitive region 122 and the dark photosensitive region 126 may have a sensitive spectral range from 0.1 μm to 10 μm, specifically from 0.5 μm to 5 μm, more specifically from 1 μm to 3 μm. The sensitive spectral range of the active photosensitive region 122 and the sensitive spectral range of the dark photosensitive region 126 may be identical, at least up to tolerances of 5%, specifically 3%, more specifically 1%. However, in principle, the sensitive spectral range of the active photosensitive region 122 and the sensitive spectral range of the dark photosensitive region 126 may also be different. As an example, the active photosensitive region 122 and the dark photosensitive region 126 may comprise different materials. However, the active photosensitive region 122 and the dark photosensitive region 126 may specifically comprise identical materials, specifically for facilitating calibration as explained above. The active photosensitive region 122 and the dark photosensitive region 126 may comprise at least one photoconductive material, in particular the identical photoconductive material. The photoconductive material may be selected from at least one of lead sulfide (PbS); lead selenide (PbSe).

The photodetector 110 may comprise at least one substrate 114. The active photosensitive region 122 and the dark photosensitive region 126 may be assembled on the same substrate 114. The active photosensitive region 122 and the dark photosensitive region 126 may be assembled on the substrate 114 in a lateral distance from edge to edge of less than 1 mm, specifically of less than 0.5 mm, more specifically of less than 0.25 mm. The substrate 114 may be a mechanical support element or a combination of mechanical support elements configured for supporting at least one further element. As an example, the substrate may be at least one planar substrate having at least one smooth, in particular planar, surface. As a further example, the substrate may be a plate-shaped or disk-shaped substrate, with two opposing surfaces, in particular planar surfaces. The substrate may typically have a thickness in the mm range.

The photodetector 110 may further comprise at least one fixture 138 attached to the substrate 114. The fixture 138 may be configured for holding the temperature equalizing cover 128. The fixture may be configured for holding the optical filter 134 arranged in the beam path of the optical radiation 112 before the active photosensitive region. The fixture 138 may generally facilitate mechanically holding the temperature equalizing cover 128 and/or the addressed optical filter 134 in place. The fixture 138 may be a mechanical carrier element or a combination of mechanical carrier elements configured for holding at least one further element. The fixture may be configured for holding the temperature equalizing cover 128 above the dark photosensitive region 126, specifically without direct contact between the temperature equalizing cover 128 and the dark photosensitive region 126. The fixture may be configured for holding the temperature equalizing cover 128 at at least one edge of the temperature equalizing cover 128. The fixture 138 may be configured for holding the addressed optical filter 134 above the active photosensitive region 122, specifically without direct contact between the optical filter 134 and the active photosensitive region 122. The fixture 138 may be configured for holding the addressed optical filter 134 at at least one edge of the optical filter 134. The fixture 138 may be configured for holding the temperature equalizing cover 128 and the addressed optical filter 134 at the same height, up to tolerances of less than 5%, specifically less than 3%, more specifically less than 1%. By using the fixture 138, a direct contact of the dark photosensitive region 126 and the temperature equalizing cover 128 as well as a direct contact of the active photosensitive region 122 and the addressed optical filter 134 may be avoided. Such a direct contact may generally cause chemical reactions in the photosensitive region 116 and thus lead to a degradation of the photosensitive region 116. As shown in FIG. 1, the fixture 138 may further surround the pixels 118 and may thus be configured for shielding the pixels 118 against environmental influences.

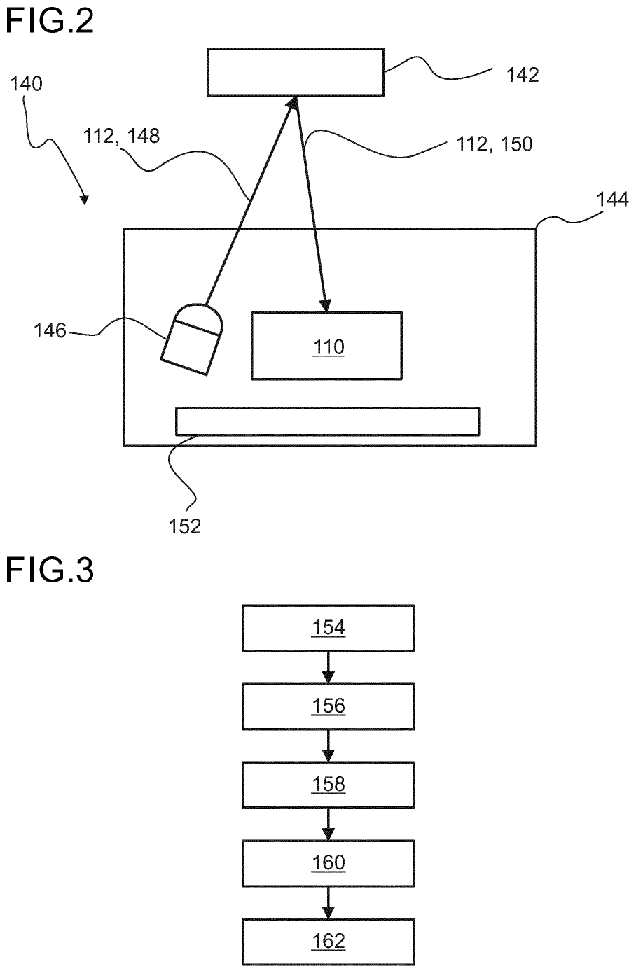

FIG. 2 shows an exemplary embodiment of a spectral measurement device 140 for spectrally analyzing optical radiation 112 provided by at least one measurement object 142 in a highly schematic fashion. The spectral measurement device 140 may be an apparatus which is configured for determining spectral information by recording at least one measured value for at least one signal intensity related to at least one corresponding signal wavelength of the optical radiation 112 and by evaluating at least one detector signal which relates to the signal intensity. Specifically, the spectral measurement device 140 may be, may comprise or may be part of at least one miniaturized apparatus. For example, the spectral measurement device may be, may comprise or may be part of at least one handheld apparatus. The handheld apparatus may be an arbitrary portable apparatus. The handheld apparatus may specifically be configured, by its dimensions and/or its weight, for being carried by a user with a single hand. Thus, as an example, a volume of the handheld apparatus may not exceed 0.001 m³, and/or the weight of the handheld apparatus may not exceed 1 kg. Specifically, the spectral measurement device may be, may comprise or may be part of at least one wearable device, specifically a smartphone or a smartwatch. The fact that the spectral measurement 140 device may be, may comprise of may be part of a miniaturized apparatus such as a handheld apparatus may specifically facilitate a consumer friendly application of the spectral measurement device. Further, the spectral measurement device 140 may comprise at least one housing 144. The housing 144 may be configured for protecting and/or shielding parts inside the housing 144 against environmental influences such as mechanical influences or electromagnetic influences.

The measurement object 142 may be an arbitrary body, chosen from a living body and a non-living body. The measurement object 142 may specifically comprise at least one material which may be subject to an investigation by the spectral measurement device 140. The measurement object 142 may generally refer to an object which is to be measured, e.g. for which a spectrum is to be recorded, wherein the object has in principle arbitrary properties, e.g. arbitrary optical properties and/or an arbitrary shape. The measurement object 142 may comprise at least one solid sample and/or at least one fluid. The 112 optical radiation provided by the measurement object 142 may be at least one of reflected, specifically diffusely; diffracted; transmitted and emitted by the measurement object. The 112 optical radiation provided by the measurement object 142 may be indicative of at least one of a physical property of the measurement object, e.g. an optical property and/or a temperature of the measurement object 142, and a chemical property of the measurement object 142, e.g. a chemical composition of the measurement object 142.

The spectral measurement device 140 comprises at least one photodetector 110 according to any one of the embodiments referring to a photodetector 110 disclosed above or below in further detail. The spectral measurement device 140 comprises at least one radiation source 146 configured for emitting optical radiation 112 at least partially towards the measurement object 142. The radiation source 146 may be an in principle arbitrary device configured for emitting the optical radiation 112. The radiation source 146 may be configured for emitting the optical radiation 112 in a spectral range from 0.1 μm to 10 μm, specifically from 0.25 μm to 5 μm, more specifically from 0.5 μm to 1 μm. Specifically, for PbS used as photosensitive region 116, the radiation source 146 may be configured for emitting the optical radiation 112 in a spectral range from 1 μm to 3 μm. Specifically, for PbSe used as photosensitive region 116, the radiation source 146 may be configured for emitting the optical radiation 112 in a spectral range from 1 μm to 5 μm. The radiation source 146 may comprise at least one of a thermal radiator and a semiconductor-based radiation source. The semiconductor-based radiation source may be selected from at least one of a light emitting diode (LED) and a laser, specifically a laser diode. The thermal radiator may comprise at least one incandescent lamp. The radiation source may be modulated.

As shown in FIG. 2, the radiation source 146 may emit the optical radiation 112, specifically an incident optical radiation 148, towards the measurement object 142. The measurement object 142 may at least partially absorb the incident optical radiation 148, which may specifically be indicative of at least one physical property of the measurement object 142 and/or at least one chemical property of the measurement object 142 such as a chemical composition of at least one material forming the measurement object 142. The measurement object 142 may further at least partially reflect the incident optical radiation 148 as reflected optical radiation 150 towards the spectral measurement device 140, specifically towards the photodetector 110. As indicated above, the photodetector 110 may detect the reflected optical radiation 150, specifically by using the active pixel 120, and may generate at least one corresponding signal, specifically the active signal described above.

The spectral measurement device 140 further comprises at least one evaluation unit 152 configured for performing a calibration of the spectral measurement device 140 by using the dark signal and further for generating at least one item of spectral information related to the measurement object 142 by using the active signal. The evaluation unit 152 may be an arbitrary device adapted to perform the named operations, preferably by using at least one data processing device and, more preferably, by using at least one processor and/or at least one application-specific integrated circuit. As an example, the at least one evaluation unit 152 may comprise at least one data processing device having a software code stored thereon comprising a number of computer commands. The evaluation unit 152 may provide one or more hardware elements for performing one or more of the named operations and/or may provide one or more processors with software running thereon for performing one or more of the named operations. As an example, the evaluation unit may comprise one or more programmable devices such as one or more computers, application-specific integrated circuits (ASICs), Digital Signal Processors (DSPs), or Field Programmable Gate Arrays (FPGAs) which are configured to perform the evaluation. Additionally or alternatively, however, the evaluation unit 152 may also fully or partially be embodied by hardware. The evaluation unit 152 may further be configured for controlling the spectral measurement device 140 or parts thereof. The evaluation unit 152 may specifically be configured for performing at least one measurement cycle in which a plurality of signals may be picked up. The information as determined by the evaluation unit 152 may be provided to at least one of a further apparatus and/or to a user, specifically in at least one of an electronic, visual, acoustic, or tactile fashion. The information as determined by the evaluation unit 152 may be stored in the memory storage and/or in a separate storage device and/or may be passed on via at least one interface, such as a wireless interface and/or a wire-bound interface.

Thus, the evaluation unit 152 may further comprise at least one interface configured for providing the item of spectral information to at least one of a user and an external device. The evaluation unit may further be configured for at least partially controlling the spectral measurement device 140. Specifically, the evaluation unit 140 may be configured for controlling at least one of the radiation source 146 and the photodetector 110. The evaluation unit 152 may at least partially be comprised by at least one electronic communication unit. The electronic communication unit may comprise at least one of a smartphone, a tablet and a stand-alone controller with a display. As an example, the spectral measurement device 140 may comprise a handheld apparatus, which may be controlled by using a smartphone and/or a tablet. Specifically, an app on the smartphone and/or the tablet may be used for sending operation commands to the spectral measurement device 140 and further for receiving and displaying the item of spectral information and/or further information related to the spectral measurement device 140. The item of spectral information may be knowledge or evidence providing a qualitative and/or quantitative description relating to at least one spectral analysis, specifically of at least one measurement object 142. The item of spectral information may comprise at least one of a physical property of the measurement object 142 and a chemical property of the measurement object 142, specifically a chemical composition of the measurement object 142. The physical property may specifically comprise an optical property such at least one absorbance of the measurement object 142 and/or at least one emissivity of the measurement object 142. The chemical composition may specifically refer to qualitative and/or quantitative information on at least one material the measurement object 142 comprises.

As said, the evaluation unit 152 is specifically also configured for performing a calibration of the spectral measurement device 140 by using the dark signal. The calibration may be a process of correcting, at least from time to time, drifting effects that may occur, in practice, in the spectral measurement device 140 or in parts of the spectral measurement device 140, specifically the photodetector 110. The drifting effects may primarily be caused by alterations related to the spectral measurement device 140 itself or by alterations having an effect onto the spectral measurement device 140. The alterations may, especially, comprise at least one of: a degradation of at least one of the radiation source 146 and the photodetector 110; a temperature drift of at least one of the radiation source 146 and the photodetector 110; a variation of an ambient temperature affecting the spectral measurement device 140; a variation of a temperature related to the spectral measurement device 140, i.e. the temperature at which the photodetector 110 and corresponding electronics may operate; a mechanical extension or contraction of at least one component as comprised by the spectral measurement device 140, especially of at least one of a mechanical housing, a holder and an optical element. However, further alterations may also be feasible. Further, electrochemical processes or physical processes such as a relaxation of long lifespan traps may lead to drifting effects. Correcting the drifting effects may particularly facilitate maintaining a reliability of measurement data, specifically the item of spectral information, specifically by avoiding that the drifting effects may distort the measurement data to such an extent that results as determined by the spectral measurement device may become inconclusive.

The calibration may comprise at least one of compensating a temperature drift; compensating a long-time drift. The drift may be a variation or a shifting of at least one entity, specifically a signal or a device used for generating the signal, over time, specifically over longer time scales such as hours or days or even longer. The variations may specifically be larger than a usual noise of the signal. As an example, the photodetector 110 may drift over time, wherein at least one signal, e.g. the dark signal, may vary, although it should be stable, apart from usual noise, since the dark photosensitive region 126 may not be illuminated. The drift of the dark signal or the dark pixel 124, respectively, may than be transferred to the active pixel 120 for calibration. The drift may have different causes, e.g. temperature variations. The temperature drift may be a drift caused by temperature variations, specifically of the spectral measurement device 140 or at least parts of the spectral measurement device 140. The temperature variations may again be caused by operation conditions of the spectral measurement device 140 or by environmental conditions of the spectral measurement device 140, e.g. an illumination or ambient temperature variations. Generally, as the skilled person will know, photodetectors 110, specifically photoconductors, may be temperature dependent, i.e. the generated signals may vary with varying temperature, which should be corrected for a reliable measurement of the optical radiation 112. Further, even with stable temperatures, the photodetector 110 may generally show a long-time drift. An explanation for this phenomenon may be long living electron-hole pairs. The long-time drift may be a drift over longer time scales, specifically hours or days or even longer, which is independent of variations relating to the spectral measurement device 140, specifically temperature variations. The long-time drift may specifically be or comprise at least one unpreventable intrinsic drift of the spectral measurement device 140 or of parts of the spectral measurement device 140, specifically of the photodetector 110, more specifically the photosensitive region 116, i.e. the active photosensitive region 122 and/or the dark photosensitive region 126.

The compensation may be a correction of at least one drift by identifying the drift and making up for the drift. As an example, a drift of a signal in one direction may be identified, e.g. a continuous decrease of the signal. Then, when processing the measured signal, the measured signal may be reset to its original value before the drift. In particular, a drift may be identified by using the dark pixel 124, specifically by evaluating the dark signal, specifically over time. A drift of the active pixel may then be compensated by using this information. In other words, the evaluation unit 152 may specifically be configured for performing a calibration of the active pixel 120, specifically of the active signal, by using the dark signal. More specifically, the evaluation unit 152 may be configured for compensating a temperature drift of the active pixel 120, specifically of the active signal, wherein the temperature drift may be identified by using the dark signal. Additionally or alternatively, the evaluation unit may be configured for compensating a long-time drift of the active pixel 120, specifically of the active signal, wherein the long-time drift may be identified by using the dark signal. The calibration may comprise compensating the drifts for reliable measurements.

FIG. 3 shows a flow chart of an exemplary embodiment of a method for spectrally analyzing optical radiation 112 provided by at least one measurement object 142. The method is performed by using at least one spectral measurement device 140 according to any one of the embodiments referring to a spectral measurement device 140 disclosed above or below in further detail. The method comprises the following steps:
a) (denoted by reference number 154) emitting optical radiation 112 at least partially towards the measurement object 142 by using the radiation source 146;
b) (denoted by reference number 156) generating at least one dark signal by using the dark pixel 124, wherein the dark signal is independent on an illumination of the dark pixel 124 by the optical radiation 112 provided by the measurement object 142;
c) (denoted by reference number 158) performing a calibration of the spectral measurement device 140 by using the evaluation unit 152 for evaluating the dark signal;
d) (denoted by reference number 160) generating at least one active signal by using the active pixel 120, wherein the active signal is dependent on an illumination of the active pixel 120 by the optical radiation 112 provided by the measurement object 142; and
e) (denoted by reference number 162) generating at least one item of spectral information related to the measurement object 142 by using the evaluation unit 152 for evaluating the active signal.

The method steps may be performed in the given order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion. For further definitions and embodiments of the method it may be referred to the definitions and embodiments of the spectral measurement device and the photodetector. Specifically, as outlined above, the calibration may comprise at least one of compensating a temperature drift; compensating a long-time drift.

The method for spectrally analyzing the optical radiation 112 provided by at least one measurement object 142 may at least partially be computer implemented. Specifically, one or more of the method steps may be performed by using a computer or computer network, more specifically by using a computer program. Thus, generally, any of the method steps including provision and/or manipulation of data may be performed by using a computer or computer network. Generally, these method steps may include any of the method steps, typically except for method steps requiring manual work, such as providing the measurement object and/or certain aspects of performing the actual measurements.

### LIST OF REFERENCE NUMBERS

110 Photodetector
112 Optical radiation
114 Substrate
116 Photosensitive region
118 Pixel
120 Active pixel
122 Active photosensitive region
124 Dark pixel
126 Dark photosensitive region
128 Temperature equalizing cover
130 Non-absorbing cover
132 Optical element
134 Optical filter
136 Optical reflector
138 Fixture
140 Spectral measurement device
142 Measurement object
144 Housing
146 Radiation source
148 Incident optical radiation
150 Reflected optical radiation
152 Evaluation unit
154 Method step a)
156 Method step b)
158 Method step c)
160 Method step d)
162 Method step e)

1. A photodetector for measuring optical radiation, the photodetector comprising:
at least one active pixel comprising an active photosensitive region, wherein the active pixel is configured for generating at least one active signal by using the active photosensitive region, wherein the active signal is dependent on an illumination of the active pixel by the optical radiation; and
at least one dark pixel comprising:
a dark photosensitive region, wherein the dark pixel is configured for generating at least one dark signal by using the dark photosensitive region, wherein the dark signal is independent on an illumination of the dark pixel by the optical radiation; and
a temperature equalizing cover configured for covering the dark photosensitive region at least against the optical radiation.

2. The photodetector according to claim 1, wherein the temperature equalizing cover is configured for equalizing heat input on the active pixel and the dark pixel.

3. The photodetector according to claim 1, wherein the temperature equalizing cover is configured for maintaining a temperature of the dark photosensitive region stable within a temperature range from −30° C. to 90° C.

4. The photodetector according to claim 1, wherein the temperature equalizing cover is configured for suppressing a temperature change of the dark photosensitive region of more than 1° C.

5. The photodetector according to claim 1, wherein the temperature equalizing cover is configured for maintaining a temperature of the dark photosensitive region at a temperature of the active photosensitive region within a temperature range from −30° C. to 90° C.

6. The photodetector according to claim 1, wherein the temperature equalizing cover is configured for maintaining a temperature difference between the active photosensitive region and the dark photosensitive region of less than 1° C.

7. The photodetector according to claim 1, wherein the temperature equalizing cover has, at least in a spectral range of the optical radiation, an absorption of less than 5%.

8. The photodetector according to claim 1, wherein the temperature equalizing cover has, at least in a sensitive spectral range of the dark photosensitive region, a transmittance of less than 5%.

9. The photodetector according to claim 1, wherein the temperature equalizing cover comprises at least one of an optical filter and an optical reflector.

10. The photodetector according to claim 1, wherein the active pixel comprises at least one optical filter arranged in a beam path of the optical radiation before the active photosensitive region, wherein the optical filter and the temperature equalizing cover have identical geometries, at least up to tolerances of 5%.

11. The photodetector according to claim 1, wherein the active photosensitive region and dark photosensitive region are of the same kind.

12. A spectral measurement device for spectrally analyzing optical radiation provided by at least one measurement object, the spectral measurement device comprising:
at least one photodetector according to claim 1;
at least one radiation source configured for emitting optical radiation at least partially towards the measurement object; and
at least one evaluation unit configured for
performing a calibration of the spectral measurement device by using the dark signal; and
generating at least one item of spectral information related to the measurement object by using the active signal.

13. The spectral measurement device according to claim 12, wherein the calibration comprises at least one of compensating a temperature drift and compensating a long-time drift.

14. A method for spectrally analyzing optical radiation provided by at least one measurement object by using at least one spectral measurement device according to claim 12, the method comprising:
a) emitting optical radiation at least partially towards the measurement object by using the radiation source;
b) generating at least one dark signal by using the dark pixel, wherein the dark signal is independent on an illumination of the dark pixel by the optical radiation provided by the measurement object;
c) performing a calibration of the spectral measurement device by using the evaluation unit for evaluating the dark signal;
d) generating at least one active signal by using the active pixel, wherein the active signal is dependent on an illumination of the active pixel by the optical radiation provided by the measurement object; and
e) generating at least one item of spectral information related to the measurement object by using the evaluation unit for evaluating the active signal.

15. A method of using a photodetector according to claim 1, the method comprising using the photodetector for a purpose selected from the group consisting of an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification; and a recycling application.
